(19) United States
(12) Patent Application Publication
(10) Pub. No.: US 2024/0262162 A1
(43) Pub. Date: Aug. 8, 2024

(54) ACTIVE AND PASSIVE HEAT EXCHANGER FOR COOLING ELECTRIC VEHICLE CHARGING HANDLES

(71) Applicant: Jevne Micheau-Cunningham, Robbinsdale, MN (US)

(72) Inventor: Jevne Micheau-Cunningham, Robbinsdale, MN (US)

(21) Appl. No.: 18/423,138

(22) Filed: Jan. 25, 2024

Related U.S. Application Data
(60) Provisional application No. 63/483,273, filed on Feb. 4, 2023.

(51) Int. Cl. B60H 1/00; B60H 1/14

(52) U.S. Cl. CPC B60H 1/00885; B60H 1/143; B60H 2001/00928

(57) ABSTRACT

A combined active and passive heat exchanger may include an electrically conducting portion, a first heat conducting portion having a first set of one or more pin fins couplable to the electrically conducting portion, a phase-change material portion couplable to the first heat conducting portion and configured to change physical states upon heat absorption, a second heat conducting portion couplable to the PCM portion via a second set of one or more pin fins, a coolant portion couplable to the second heat conducting portion, with a thermal spacer optionally positioned between the PCM portion and the coolant portion. The combined active and passive heat exchanger is configured to provide active and passive cooling to an electric vehicle charging handle or an electric vehicle inlet. Examples of such charging handles are also described for both alternating and direct current charging configurations and configurations that use both current types.

### CROSS-REFERENCE TO RELATED APPLICATION

The present application claims the benefit of U.S. Provisional Application No. 63/483,273, filed Feb. 4, 2023, which is hereby incorporated by reference in its entirety.

### FIELD

The present disclosure generally relates to a combined active and passive heat exchanger for cooling electrically conductive pathways during the transfer of electric current between an electric vehicle and a voltage source such as an electric charger.

### BACKGROUND

During charging and discharging of an electric vehicle (EV) battery system from or to a power source or sink, heating occurs in the system conductors, specifically the vehicle to charging infrastructure couplers. This heating, referred to as Joule heating, is a physical phenomenon where heat is generated when an electric current is passed through an electrically conductive material. In the EV to charging station system, the electrically conductive materials are specifically the metallic contact pins in the charging handle and the mating vehicle inlet plug of the charging system or EV.

Heating between the electrically conductive materials can lead to catastrophic failure of the charging handle and/or the inlet plug due to melting of polymer components. Damage may also occur to peripheral electronics required for the system to function that are located in or near the mating junction between the handle and the plug.

As such, there is a need for solutions to resolve excessive heating during EV charging. The present disclosure addresses this need through description of a combined active and passive heat exchanger for use within an EV charging handle. The heat exchanger is designed in a manner that cools the electrically conductive pathways connecting the charging handle to the EV during the transfer of electric current. Moreover, the present disclosure describes several EV charging handle designs that the combined active and passive heat exchanger can be used with. The described EV charging handles may include a universal handle portion suitable for use with each charging handle design.

### SUMMARY

Embodiments described or otherwise contemplated herein provide the advantages of improved EV charging usability, safety, and user comfort, among other advantages. The embodiments enable EV charging at temperatures designated safe by government regulatory bodies, in addition to satisfying required geometric constraints for EV charging handles and systems. Moreover, embodiments described or otherwise contemplated herein may be used with a variety of EV charging handles with limited to no loss of design or functionality characteristics.

In particular, one aspect of the disclosure relates to cooling mated electrical contact points between an EV charging handle and an EV inlet interface (i.e., inlet of an EV) directly rather than cooling the charging cable itself. Cooling the mated electrical contact points directly provides better heat transfer properties because the contact points are the source of heat generation during charging, and thus provide the most immediate disbursement of heat into the charging handle and/or the EV inlet. In contrast, cooling the charging cable itself is not as efficient for heat transfer purposes because the electrical contact points, which generate the most heat, cannot be cooled by extension of cooling the cable.

Another aspect of the disclosure enables cooling of the terminal side and the EV coupling side simultaneously, while integrating a passive cooling layer (e.g., a phase change material) with an active cooling layer (e.g., circulating air and/or fluid) into the required geometric form factor. Conventional EV charging heat exchangers have not incorporated both active and passive cooling together because of the limited space within an EV charging handle and/or at the EV inlet, as well as the complexities of efficiently apportioning heat absorption between two different cooling sources. The limited space restricts heat exchangers to either an active or a passive cooling solution which inhibits electric current transmission during charging thereby increasing charging times. Increasing electric current transmission while maintaining suitable heat transfer properties to decrease charging handle temperature enables quicker charging times and safer operation of EV charging systems overall.

In an embodiment, a combined active and passive heat exchanger for use during electric vehicle charging may include an electrically conducting portion configured to receive electric current from an external source, the electric current creating heat generation in the electrically conducting portion. The heat exchanger may further include a first heat conducting portion couplable to the electrically conducting portion, the first heat conducting portion configured to receive the heat generation from the electrically conducting portion. The heat exchanger may further include a phase change material (PCM) portion including a PCM configured to change physical state in response to heat absorption, the PCM portion couplable to the first heat conducting portion such that the heat generation is absorbed by the PCM portion. The PCM portion can be configured to retain a first quantity of the heat generation.

The heat exchanger may further include a second heat conducting portion couplable to the PCM portion, the second heat conducting portion configured to receive a second quantity of the heat generation from the PCM portion. The heat exchanger portion may further include a coolant portion couplable to the second heat conducting portion, the coolant portion configured to receive the second quantity of heat generation from the second heat conducting portion, the coolant portion configured to cool the second quantity of heat generation using a fluid circulating through the coolant portion. Absorption of the first quantity of heat generation by the PCM portion and cooling of the second quantity of heat generation by the coolant portion may decrease the temperature of the external source.

In an embodiment, the first heat conducting portion can be configured to receive the heat generation from the electrically conducting portion via a first set of one or more pin fins. In an embodiment, the first set of one or more pin fins can be in contact with the electrically conducting portion. In an embodiment, the PCM portion can be configured to change from a solid to a liquid, and from a liquid to a solid. In an embodiment, the second heat conducting portion can be configured to receive the second quantity of the heat generation from the PCM portion via a second set of one or more pin fins. In an embodiment, the coolant portion may include an inlet for receiving the fluid and an outlet for removing the fluid, the inlet and the outlet being connected by one or more internal channels in the coolant portion to enable circulation of the fluid therein. In an embodiment, the external source can be an electrical contact located within an electric vehicle charging handle. In an embodiment, the external source can be a charging inlet of an electric vehicle. In an embodiment, the first and second quantities of heat generation can be apportioned between the PCM portion and the coolant portion to maximize heat absorption by the PCM portion. In an embodiment, the heat exchanger may further include a thermal spacer of very, very low thermal conductivity positioned between the PCM portion and the coolant portion.

In an embodiment, a combined active and passive heat exchanger for use during electric vehicle charging may include an electrically conducting portion configured to receive electric current from an external source, the electric current creating heat generation in the electrically conducting portion. The heat exchanger may further include a first heat conducting portion in contact with the electrically conducting portion, the first heat conducting portion configured to receive the heat generation from the electrically conducting portion via a first set of one or more pin fins. The heat exchanger may further include a phase change material (PCM) portion including a PCM configured to change physical states in response to heat absorption, the PCM portion being in contact with the first heat conducting portion such that the heat generation is absorbed by the PCM portion. The PCM portion can be configured to retain a first quantity of the heat generation.

The heat exchanger may further include a second heat conducting portion in contact with the PCM portion, the second heat conducting portion configured to receive a second quantity of the heat generation from the PCM portion via a second set of one or more pin fins. The heat exchanger may further include a coolant portion in contact with the second heat conducting portion, the coolant portion configured to receive the second quantity of heat generation from the second heat conducting portion, the coolant portion having an inlet for receiving fluid and an outlet for removing the fluid, the inlet and the outlet being connected by one or more internal channels in the coolant portion, wherein the coolant portion can be configured to cool the second quantity of heat generation using a fluid circulating through the one or more internal channels. Absorption of the first quantity of heat generation by the PCM portion and cooling of the second quantity of heat generation by the coolant portion can decrease the temperature of the external source.

In an embodiment, the first and second sets of one or more pin fins can be interlaced within a plurality of apertures defined by the PCM portion. In an embodiment, the electrically conducting portion can be in direct contact with the external source such that the heat generation from the electric current is received entirely by the electrically conducting portion. In an embodiment, the PCM portion can be configured to change from a solid to a liquid, and from a liquid to a solid. In an embodiment, the external source can be an electrical contact located within an electric vehicle charging handle. In an embodiment, the external source can be a charging inlet of an electric vehicle. In an embodiment, the first and second quantities of heat generation can be apportioned between the PCM portion and the coolant portion to maximize heat absorption by the PCM portion. In an embodiment, the heat exchanger may further include a thermal spacer positioned between the PCM portion and the coolant portion, the thermal spacer including an opening through which the second set of one or more pin fins are received.

In an embodiment, an electric vehicle charging handle may include a housing, a cable connector portion couplable to the housing, the cable connector portion configured to receive an electric cable for transferring electric current into the charging handle. The charging handle may further include a handle portion couplable to the housing and to the cable connector portion, the handle portion configured for gripping by a user of the charging handle. The charging handle may further include a mating portion configured for connection to an electric vehicle inlet, and a combined active and passive heat exchanger disposed within the housing, the heat exchanger being in electrical contact with the cable connector portion such that electric current from the electric cable can be received by the heat exchanger. The heat exchanger can be configured to passively cool heat generation by the electric current using a phase change material and configured to actively cool the heat generation using a circulating fluid. Passive and active cooling can decrease the temperature within the electric vehicle charging handle. In an embodiment, the handle portion may include an attachment mechanism configured to couple and decouple the handle portion from both the housing and the cable connector portion.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIGS. 1A and 1B are perspective views of a combined active and passive heat exchanger, according to embodiments of the present disclosure.

FIGS. 2A and 2B are top and bottom views, respectively, of a combined active and passive heat exchanger, according to embodiments of the present disclosure.

FIGS. 2C and 2D are left and right side views, respectively, of a combined active and passive heat exchanger, according to embodiments of the present disclosure.

FIGS. 2E and 2F are rear and front views, respectively, of a combined active and passive heat exchanger, according to embodiments of the present disclosure.

FIG. 3 is an exploded view of a combined active and passive heat exchanger, according to an embodiment of the present disclosure.

FIG. 4A is a perspective view of an electrically conducting portion and a first heat conducting portion for use with a combined active and passive heat exchanger, according to an embodiment of the present disclosure.

FIG. 4B is a top view of the electrically conducting portion and the first heat conducting portion from FIG. 4A.

FIG. 5A is a perspective view of a phase change material portion for use with a combined active and passive heat exchanger, according to an embodiment of the present disclosure.

FIG. 5B is a top view of the phase change material portion from FIG. 5A.

FIG. 6A is a perspective view of a coolant portion and a second heat conducting portion for use with a combined active and passive heat exchanger, according to an embodiment of the present disclosure.

FIG. 6B is a perspective view of the coolant portion and the second heat conducting portion from FIG. 6A.

FIG. 6C is a bottom view of the coolant portion and the second heat conducting portion from FIG. 6A.

FIG. 7A is a perspective view of a thermal spacer for use with a combined active and passive heat exchanger, according to an embodiment of the present disclosure.

FIG. 7B is a side view of the thermal spacer from FIG. 7A.

FIG. 8A is a right side cross-sectional view of a combined active and passive heat exchanger, according to an embodiment of the present disclosure.

FIG. 8B is a rear cross-sectional view of a combined active and passive heat exchanger, according to an embodiment of the present disclosure.

FIG. 9 is a block diagram of a combined active and passive heat exchanger, according to an embodiment of the present disclosure.

FIG. 10 is a diagram illustrating simultaneous application of a combined active and passive heat exchanger with a charging handle and with an electric vehicle, according to an embodiment of the present disclosure.

FIG. 11 is a perspective view of a first charging handle for use with an electric vehicle, according to an embodiment of the present disclosure.

FIGS. 12A and 12B are top and bottom views, respectively, of a first charging handle for use with an electric vehicle, according to embodiments of the present disclosure.

FIGS. 12C and 12D are right and left side views, respectively, of a first charging handle for use with an electric vehicle, according to embodiments of the present disclosure.

FIGS. 12E and 12F are front and rear views, respectively, of a first charging handle for use with an electric vehicle, according to embodiments of the present disclosure.

FIG. 13 is an exploded view of a first charging handle for use with an electric vehicle, according to an embodiment of the present disclosure.

FIGS. 14A, 14B, and 14C are detail exploded views of the first charging handle from FIG. 13.

FIG. 15 is a left side cross-sectional view of a first charging handle for use with an electric vehicle, according to an embodiment of the present disclosure.

FIG. 16 is a perspective view of a second charging handle for use with an electric vehicle, according to an embodiment of the present disclosure.

FIGS. 17A and 17B are top and bottom views, respectively, of a second charging handle for use with an electric vehicle, according to embodiments of the present disclosure.

FIGS. 17C and 17D are right and left side views, respectively, of a second charging handle for use with an electric vehicle, according to embodiments of the present disclosure.

FIGS. 17E and 17F are front and rear views, respectively, of a second charging handle for use with an electric vehicle, according to embodiments of the present disclosure.

FIG. 18 is an exploded view of a second charging handle for use with an electric vehicle, according to an embodiment of the present disclosure.

FIGS. 19A and 19B are detail exploded views of the second charging handle from FIG. 18.

FIG. 20 is a left side cross-sectional view of a second charging handle for use with an electric vehicle, according to an embodiment of the present disclosure.

FIG. 21 is a perspective view of a third charging handle for use with an electric vehicle, according to an embodiment of the present disclosure.

FIGS. 22A and 22B are top and bottom views, respectively, of a third charging handle for use with an electric vehicle, according to embodiments of the present disclosure.

FIGS. 22C and 22D are right and left side views, respectively, of a third charging handle for use with an electric vehicle, according to embodiments of the present disclosure.

FIGS. 22E and 22F are front and rear views, respectively, of a third charging handle for use with an electric vehicle, according to embodiments of the present disclosure.

FIG. 23 is a left side cross-sectional view of a third charging handle for use with an electric vehicle, according to an embodiment of the present disclosure.

FIG. 24 is left side views of the charging handles from FIGS. 12D, 17D, and 22D, organized from top to bottom, illustrating a universal handle portion, according to embodiments of the present disclosure.

FIG. 25 is front views of the charging handles from FIGS. 12E, 17E, and 22E, organized from left to right, illustrating a universal handle portion, according to embodiments of the present disclosure.

FIG. 26 is a perspective view of a universal handle portion for use with a charging handle, according to an embodiment of the present disclosure.

FIGS. 27A and 27B are top and bottom views, respectively, of a universal handle portion for use with a charging handle, according to embodiments of the present disclosure.

FIGS. 27C and 27D are right and left side views, respectively, of a universal handle portion for use with a charging handle, according to embodiments of the present disclosure.

FIGS. 27E and 27F are front and rear views, respectively, of a universal handle portion for use with a charging handle, according to embodiments of the present disclosure.

While various embodiments are amenable to various modifications and alternative forms, specifics thereof have been shown by way of example in the drawings and will be described in detail. It should be understood, however, that the intention is not to limit the claims to the particular embodiments described. On the contrary, the intention is to cover all modifications, equivalents, and alternatives falling within the spirit and scope of the subject matter as defined by the claims.

### DETAILED DESCRIPTION OF THE DRAWINGS

The following detailed description should be read with reference to the drawings in which similar elements in different drawings are numbered the same. The drawings, which are not necessarily to scale, depict illustrative embodiments and are not intended to limit the scope of the disclosure.

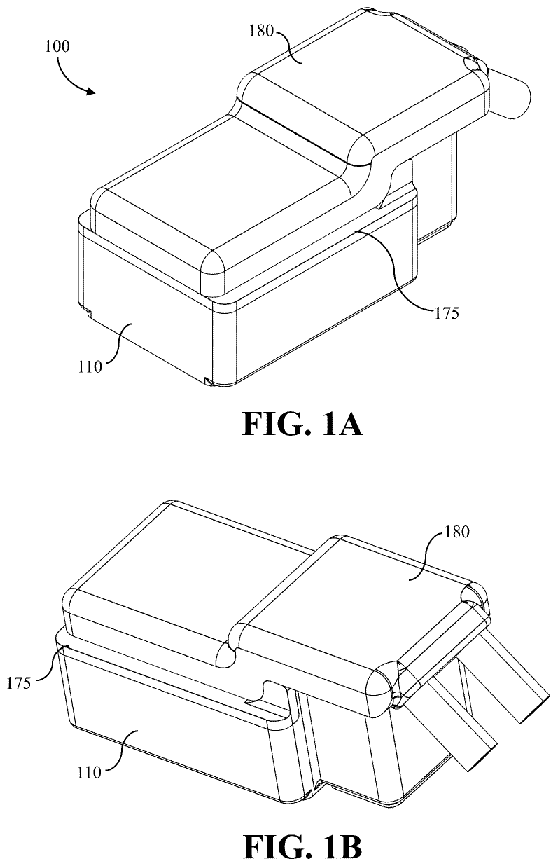

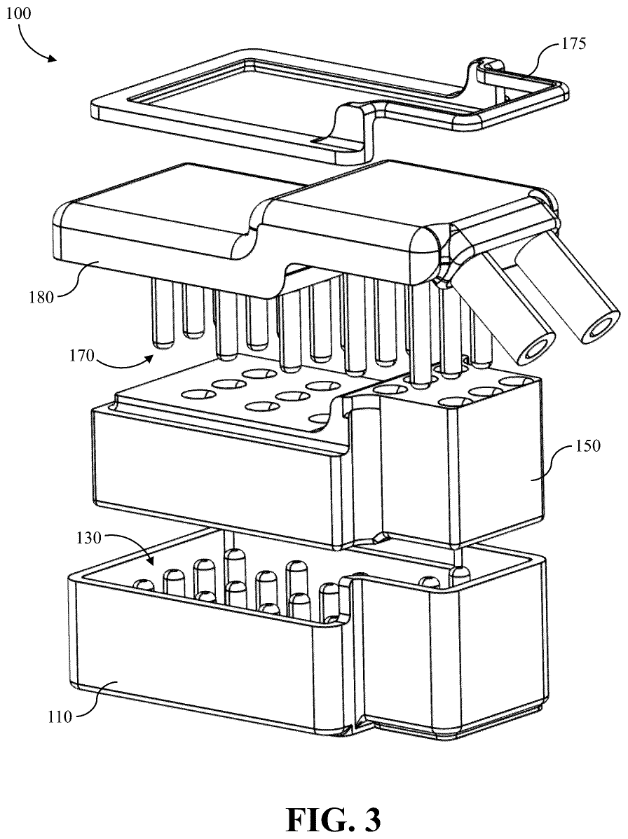

Referring generally to FIGS. 1A-8B, a combined active and passive heat exchanger (“heat exchanger”) 100 may include an electrically conducting portion 110, a first heat conducting portion 130 couplable to the electrically conducting portion 110, a phase-change material (PCM) portion 150 couplable to the first heat conducting portion 130 and positioned within the electrically conducting portion 110, a second heat conducting portion 170 couplable to the PCM portion 150, a coolant portion 180 couplable to the second heat conducting portion 170 (and to the PCM portion 150 via the second heat conducting portion 170), with a thermal spacer 175 positioned between a top surface of the PCM portion 150 and a bottom surface of the coolant portion 180. It should be understood that heat exchanger 100 can comprise multiple, separate portions as described here, or that heat exchanger 100 can comprise an integral assembly with one or more of the described portions integrated together into a single piece.

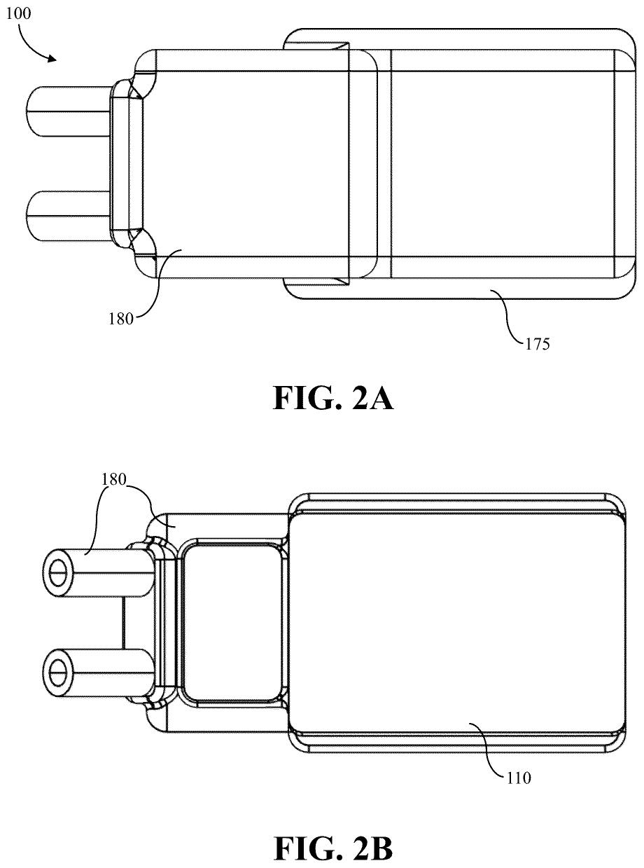

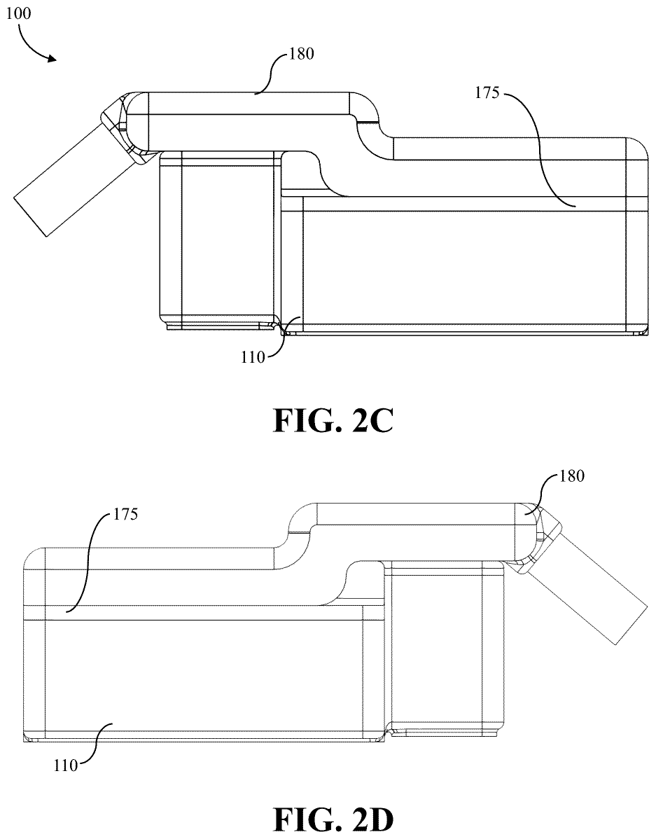

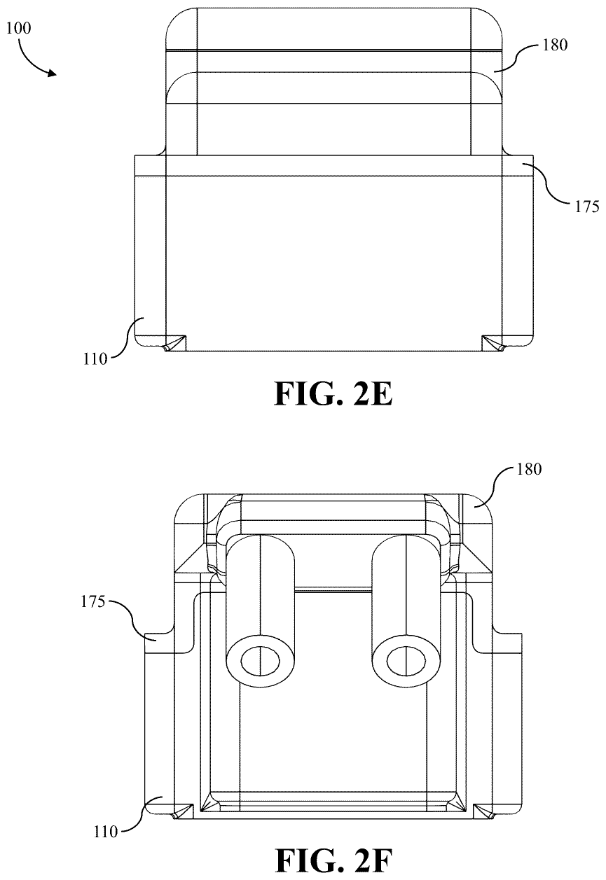

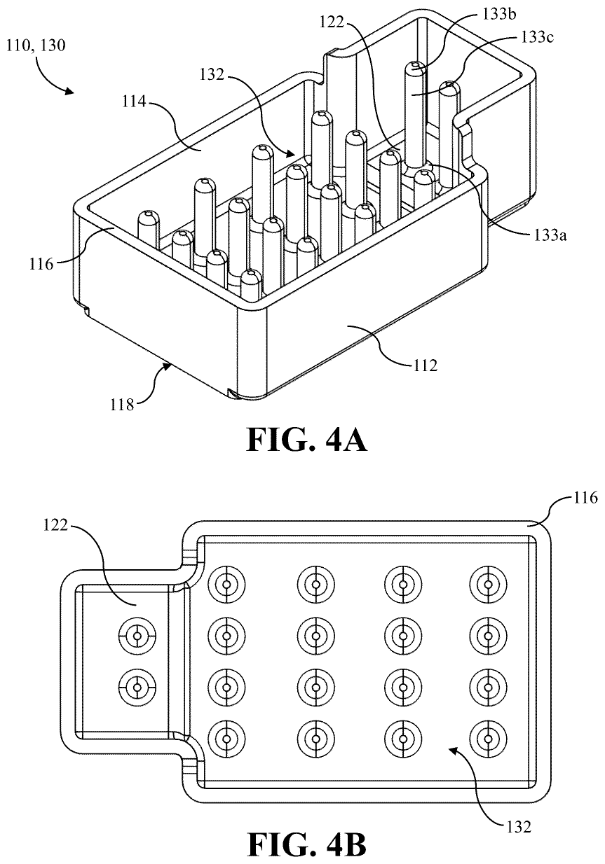

In reference particularly to FIGS. 4A and 4B, electrically conducting portion 110 generally comprises a thin-walled structure having an outer wall 112 opposite an inner wall 114, with a top surface 116 connecting the outer and inner walls 112, 114. The thin-walled structure can also include a bottom surface 118 opposite the top surface 116, with a base 122 located within the enclosure of electrically conducting portion 110. As illustrated in the figures, electrically conducting portion 110 can have a substantially rectangular geometry with an elevated portion couplable to a lowered portion. In an embodiment, the bottom surface 118 of the elevated portion may be positioned a distance above the bottom surface 118 of the lowered portion as illustrated, for example, in FIGS. 2C and 2D. In such an embodiment, the section of base 122 included with the elevated portion is offset an equivalent distance from the section of base 122 included with the lowered section.

With the substantially rectangular geometry, electrically conducting portion 110 may have various aesthetic design features such as rounded edges, chamfered regions, and/or a bottom surface 118 with an indented and filleted perimeter edge. In embodiments, electrically conducting portion 110 may have other geometries such as substantially cylindrical, square, triangular, spherical, or any other geometry suitable for heat exchanger 100, along with corresponding aesthetic design features such as those described previously. As the name suggests, electrically conducting portion 110 is commonly made from an electrically conductive material such as a metal like copper, stainless steel, aluminum, or titanium, for example. Other electrically conductive materials may be used in place of a metal, assuming suitable electric characteristics (e.g., similar electric conductivity).

The section of electrically conducting portion 110 between inner wall 114, top surface 116, and base 122 is generally hollow such that the first and second heat conducting portions 130, 170 and the PCM portion 150 can be received therein. The hollow section may vary in size depending on the thickness of the thin-walled structure that separates the outer and inner walls 112, 114. In an embodiment, the thickness of the structure can be approximately in the range of 0.0625 to 0.125 inches, though other suitable thicknesses less than or greater than this range are contemplated by this disclosure. Accordingly, the area of base 122 can vary in such an embodiment between approximately three and 15 inches-squared, for example. Other suitable area measurements for base 122 are contemplated by this disclosure, so long as they are suitable for use within a charging handle and/or an EV inlet interface.

In reference particularly to FIGS. 4A and 4B, first heat conducting portion 130 is generally contained entirely within the hollow section of electrically conducting portion 110. First heat conducting portion 130 may include a plurality of pin fins 132 (or one or more pin fins 132) each having a cylindrical geometry with a pin fin bottom surface 133a separated from a pin fin top surface 133b by a pin fin length 133c (i.e., the tube section separating the top and bottom surfaces as illustrated). In embodiments, one or more or all of the plurality of pin fins 132 may have a different geometry such as rectangular, spherical, triangular, tapered square, S-shaped, or another geometry optimized for maximum heat transfer. In embodiments, plurality of pin fins 132 may comprise 18 individual pin fins 132 or any other number of pin fins 132 less than or greater than 18. As illustrated, plurality of pin fins 132 are generally arranged in straight or substantially straight lines (e.g., in a line of four), though in other embodiments the plurality of pin fins 132 may be arranged in irregular configurations such as curved or jagged lines.

Plurality of pin fins 132 may be manufactured from a variety of materials including metals such as copper, stainless steel, aluminum, or titanium, for example. Generally, when designed to have the illustrated cylindrical geometry, the pin fin bottom surface 133a of each pin fin 132 is couplable to the base 122 of the electrically conducting portion 110. When PCM portion 150 is included within electrically conducting portion 110, the pin fin top surface 133b and length 133c are generally received within the PCM portion 150 to effectuate the transfer of heat therein. In an embodiment, each pin fin 132 may have a combined length from pin fin bottom surface 133a to pin fin top surface 133c of approximately one inch, though other suitable combined length measurements less than or greater than one inch are contemplated by this disclosure. In an embodiment, first heat conducting portion 130 may include a different type of pin fin configuration other than plurality of pin fins 132 (i.e., an array of pin fins). For example, first heat conducting portion 130 may include a structure having a plurality of walls shaped linearly or shaped similar to a maze, to effectuate heat transfer therein instead of, or in addition to, using pin fins 132.

The coupling of electrically conductive portion 110 and first heat conducting portion 130 can effectuate the transfer of heat generated by an electric current. The electric current can be received from an external source such as an electrical contact located within an EV charging handle or a charging inlet of an EV, the electric current flowing through electrically conductive portion 110. Generally, the generated heat flows from portion 110 through one or more or all of the plurality of fins 132 of portion 130, and subsequently into the PCM portion 150 for absorption and/or further heat transfer.

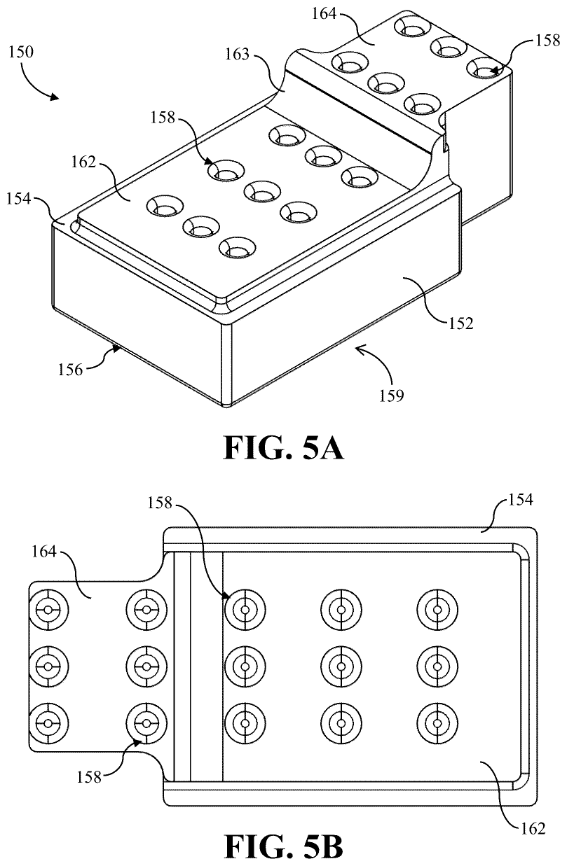

In reference particularly to FIGS. 5A and 5B, PCM portion 150 may have a substantially rectangular geometry with an outer wall 152 separating a top surface 154 from a bottom surface 156. PCM portion 150 may further include a first elevated portion 162 and a second elevated portion 164 couplable together by a ramp 163, the second elevated portion 164 being offset a distance from the first elevated portion 162 to match the elevated and lowered portions of the electrically conducting portion 110. First or second elevated portions 162, 164 may include various aesthetic design features such as rounded/filleted edges, chamfered regions, and/or indented areas.

In an embodiment, ramp 163 may have a rounded surface to provide a clean transition from first elevated portion 162 to second elevated portion 164, as illustrated by FIG. 5A for example. PCM portion 150 may further include a first set of apertures 158 arranged in a pattern on both the first and second elevated portions 162, 164, and a second set of apertures 159 arranged on bottom surface 156 in a pattern that matches the pattern of plurality of pin fins 132 of first heat conducting portion 130. As illustrated, plurality of apertures 158 may include nine equally spaced apertures 158 on first elevated portion 162 and six equally spaced apertures 158 on second elevated portion 164, though other aperture 158 numbers less than or greater than six are contemplated for both elevated portions 162, 164. To match the illustrated number of pin fins 132, second set of apertures 159 may include 18 individual apertures 159 or any other number of apertures 159 less than or greater than 18 (so long as the number of apertures 159 is equal to the number of pin fins 132).

First set of apertures 158 can be configured to receive plurality of pin fins 172 of second heat conducting portion 170 (pin fins 172 can be designed similarly to pin fins 132; in an embodiment, plurality of pin fins 172 may be one or more pin fins 172). As such, plurality of apertures 158 can be sized and/or dimensioned similar to the geometry of pin fins 172 to create contact between pins fins 172 and the inside of apertures 158 when pin fins 172 are inserted therein.

Similarly, second set of apertures 159 can be configured to receive plurality of pin fins 132 and can accordingly be sized and/or dimension similar to the geometry of pin fins 132 to create contact between pin fins 132 and the inside of apertures 159 when pin fins 132 are inserted therein. When received within PCM portion 150, the interlaced plurality of pin fins 132, 172 can transfer heat between each other and to the surrounding solid PCM portion 150 which can then change its physical state, at least partially, from solid to liquid by absorbing excess heat. The PCM portion 150 thus acts as a passive heat reservoir by absorbing heat without requiring any external or secondary action.

As the name suggests, PCM portion 150 may utilize a phase change material to operate as a passive heat reservoir. Phase change materials are substances which absorb or release large amounts of latent heat when the materials undergo a change in physical state (e.g., from a solid state to a liquid or semi-liquid state, or vice versa). Examples of phase change materials for use with PCM portion 150 include, but are not limited to, eutectics, salt hydrates (i.e., inorganic materials), organic materials, hygroscopic materials, sub-zero eutectic materials, ultra-low temperature materials, positive temperature salt hydrate materials, positive temperature organic materials, and high temperature salt materials. As used with PCM portion 150, eutectics tend to be solutions of salts in water that have a phase change temperature below 0° C. (32° F.). Salt hydrates may be specific salts configured to incorporate water of crystallization during their freezing process. Such salt hydrates tend to change phase (i.e., physical state) above 0° C. (32° F.). Organic materials tend to be polymers with long chain molecules composed primarily of carbon and hydrogen. Such materials tend to exhibit high orders of crystallinity when freezing and mostly change phases above 0° C. (32° F.). Examples of materials used as positive temperature organic materials include waxes, oils, fatty acids, and polyglycols. Examples of organic materials include hydrocarbons such as paraffin, sugar alcohols, and lipids.

Another example of a phase change material that can be used with PCM portion 150 are solid-solid phase change materials. These materials can experience a solid-to-solid phase transition while absorbing and releasing substantial amounts of heat in the process of changing phases. At a given and well-defined temperature, these materials can alter their crystalline structure from one lattice configuration to another, and the transformation can include latent temperatures comparable to some of the most successful solid-to-liquid transition phase change materials.

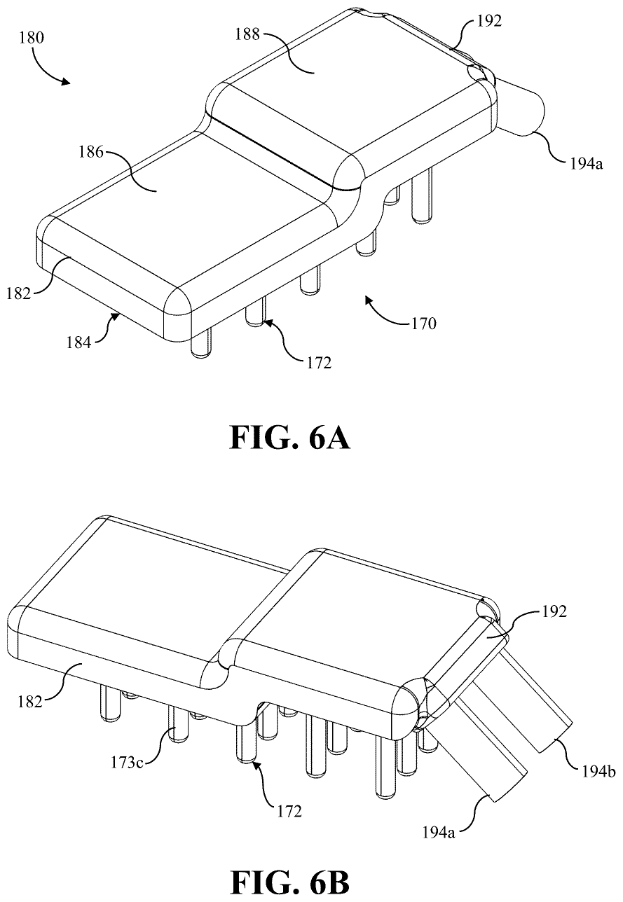

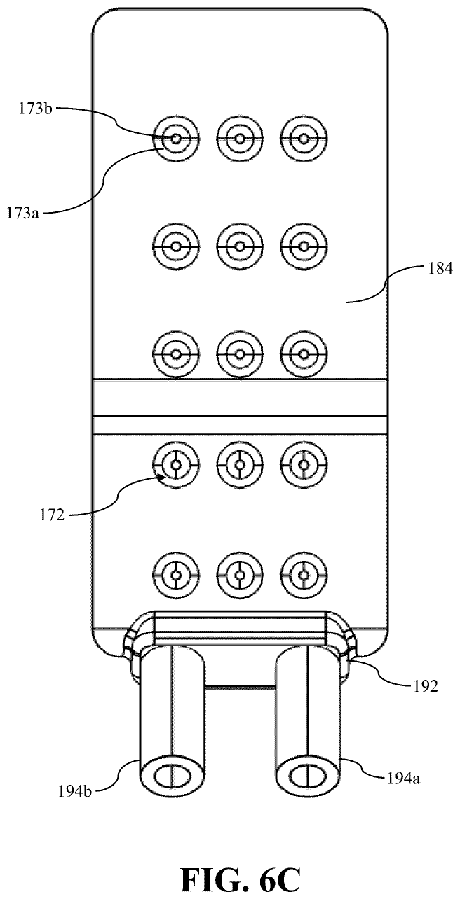

In reference particularly to FIGS. 6A-6C, second heat conducting portion 170 is generally couplable to a bottom surface 184 of coolant portion 180 in a similar manner as first heat conducting and electrically conducting portions 130, 110. Second heat conducting portion 170 may include a plurality of pin fins 172 each having a cylindrical geometry with a pin fin bottom surface 173a separated from a pin fin top surface 173b by a pin fin length 173c (i.e., the tube section separating the top and bottom surfaces as illustrated). In embodiments, one or more or all of the plurality of pin fins 172 may have a different geometry such as rectangular, spherical, triangular, tapered square, S-shaped, or another geometry optimized for maximum heat transfer. In embodiments, plurality of pin fins 172 may comprise 15 individual pin fins 172 or any other number of pin fins 172 less than or greater than 15. As illustrated, plurality of pin fins 172 are generally arranged in straight or substantially straight lines (e.g., in a line of three), though in other embodiments the plurality of pin fins 172 may be arranged in irregular configurations such as curved or jagged lines.

Plurality of pin fins 172 may be manufactured from the same materials as plurality of pin fins 132. Generally, when designed to have the illustrated cylindrical geometry, the pin fin bottom surface 173a of each pin fin 172 is couplable to the bottom surface 184 of the coolant portion 180. When PCM portion 150 is coupled to second heat conducting portion 170, the pin fin top surface 173b and length 173c are generally received within the PCM portion 150 to effectuate the transfer of heat therein. In an embodiment, each pin fin 172 may have a combined length equivalent, substantially similar to, or different than, the combined length of pin fin 132. In an embodiment, second heat conducting portion 170 may include a different type of pin fin configuration other than the configuration illustrated for plurality of pin fins 172. For example, second heat conducting portion 170 may include a structure having a plurality of walls shaped linearly or shaped similar to a maze, to effectuate heat transfer therein instead of, or in addition to, using pin fins 172.

In reference particularly to FIGS. 6A-6C, coolant portion 180 generally has a substantially rectangular geometry separated between a first elevated portion 186 and a second elevated portion 188. First and second elevated portions 186, 188 may be offset from each other by a distance corresponding to the offset distance between first and second elevated portions 162, 164 of PCM portion 150.

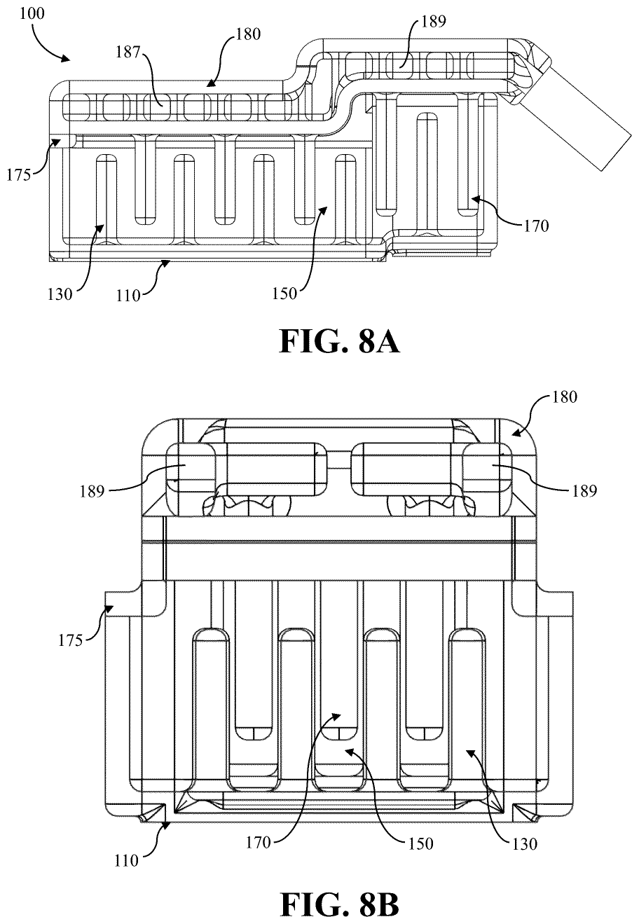

As illustrated particularly in the cross-section views of FIGS. 8A and 8B, coolant portion 180 may include one or more lower channels 187 integrated within first elevated portion 186 and one or more upper channels 189 integrated within second elevated portion 188. The one or more lower and upper channels 187, 189 can enable the flow of coolant into and out of coolant portion 180 as described further in the next paragraph. In an embodiment, coolant portion 180 may have one or more lower and upper channels 187, 189 for both coolant entrance and coolant exit into portion 180. An outer wall 182 forms the perimeter of first and second elevated portions 186, 188 and is generally oriented perpendicular to a bottom surface 184, where plurality of pin fins 172 are typically couplable to. In an embodiment, outer wall 182 may have various aesthetic design features such as rounded edges, chamfered regions, and/or an indented and filleted perimeter edge, for example.

Second elevated portion 188 can include a coolant connector 192 that itself can be couplable to a coolant inlet 194a and a coolant outlet 194b. Coolant inlet 194a and coolant outlet 194b enable coolant, for example circulating air and/or fluid, to enter or exit, respectively, the body of coolant portion 180. As shown particularly in FIG. 6C, coolant inlet 194a and coolant outlet 194b generally have a cylindrical geometry with an opening extending through their geometries, with both being configured to receive coolant through their respective openings. In operation, coolant can be received by coolant inlet 194a through its opening and transferred to one or more upper channels 189 coupled to the coolant inlet 194a. The coolant can then be transferred from the one or more upper channels 189 to one or more lower channels 187 integrated within first elevated portion 186. Coolant is thus dispersed through the entirety of coolant portion 180.

On return, the coolant can be transferred to a separate one or more lower channels 187 (or the same lower channel(s) 187 as mentioned previously) and can then flow into a separate one or more lower channels 189 (or the same upper channel(s) as mentioned previously) before exiting coolant portion 180 through the opening of coolant outlet 194b. Accordingly, the pathway between the coolant inlet 194a, the one or more lower and upper channels 187, 189, and the coolant outlet 194b, can be used to enable the transfer of coolant, for example circulating air and/or fluid, through coolant portion 180 to actively cool any heat transferred away from PCM portion 150. In combination, PCM portion 150 and coolant portion 180 enable passive and active cooling, respectively, of electrical contact points or pathways using heat exchanger 100.

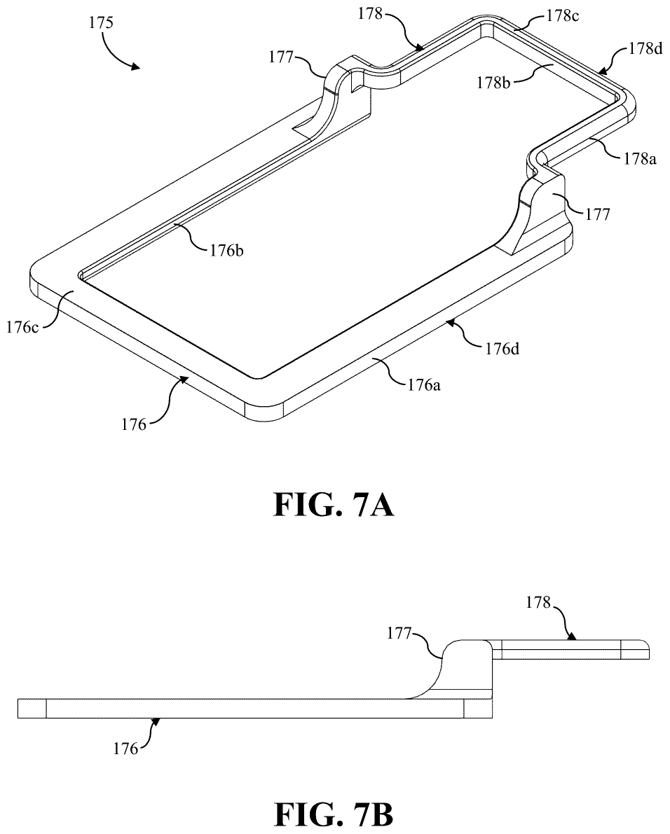

In reference particularly to FIGS. 7A and 7B, thermal spacer 175 may include a lower portion 176 couplable to an upper portion 178 via a pair of connecting structures 177. The lower portion 176 may include an outer wall 176a separated from an inner wall 176b by a top surface 176c on one side and by a bottom surface 176d on the other side. Similarly, upper portion 178 may include an outer wall 178a separated from an inner wall 178b by a top surface 178c on one side and by a bottom surface 178d on the other side. Generally, the geometry of thermal spacer 175 can be characterized as substantially rectangular, similar to the geometries of portions 110, 150, and 180. Upper portion 178 may be offset from lower portion 176 by a distance equivalent to the offset distance of first and second elevated portions 162, 164 of PCM portion 150 (this distance is also equal to the length of connecting structure 177). In the illustrated embodiment, thermal spacer 175 includes an opening formed by the inner walls 176b, 178b and the pair of connecting structures 177.

Generally, thermal spacer 175 is configured to fill a gap between PCM portion 150 and coolant portion 180. Thermal spacer 175 may abut top surface 154 of PCM portion 150 and bottom surface 184 of coolant portion 180 to form a seal to prevent heat leakage out of heat exchanger 100 and into the charging handle or EV inlet interface. In embodiments, thermal spacer 175 may be integrated directly with PCM portion 150 and/or with coolant portion 180 rather than being a separate, removable element of heat exchanger 100 as described here. Thermal spacer 175 may be manufactured from a variety of materials with very low thermal conductivities such that heat generation is not shunted around the favored heat transfer path through PCM portion 150.

As illustrated particularly in FIGS. 8A and 8B, the various components of heat exchanger 100 are configured to fit together to form a single integrated structure. The interlaced spacing between plurality of pin fins 132, 172 when coupled together in heat exchanger 100 is illustrated in these figures. The close spacing enables the transfer of generated heat from pin fins 132 to pin fins 172 (either plurality or one or more pin fins 132, 172). In embodiments, the various components may be manufactured separately and then assembled together to form heat exchanger 100, or may be manufactured altogether into a heat exchanger 100 with integrated portions. Tolerances for elements such as pin fins 132, 172 and sets of apertures 158, 159 may be selected to ensure suitable heat transfer contact between the elements to effectuate the efficient transfer of heat through heat exchanger 100. For example, tolerances may range from +/−1% to 5% depending on the type of element (e.g., mating elements may require closer tolerances whereas non-mating elements can have looser tolerances).

Heat exchanger 100 may comprise several different form factors suitable for use within an EV charging handle and in compliance with relevant government regulations. For example, heat exchanger 100 may have a volume of approximately five to 15 cubic inches, though other volumes less than or greater than this range are contemplated by the disclosure.

In full operation of heat exchanger 100, heat is generated by passing an electric current through electrically conducting portion 110 (typically referred to as “Joule heating”). Generally, electrically conducting portion 110 comprises two parallel electrical conductors which carry the direct current (DC), alternating current (AC), or a combination of AC and DC current for the EV battery. The Joule-heated electrically conducting portion 110 can transfer the generated heat to the first heat conducting portion 130 through physical contact between portion 110 and the plurality of pin fins 132 of portion 130. The transfer of generated heat causes the temperature of first heat conducting portion 130 to increase. The generated heat is then transferred from the first heat conducting portion 130 to the PCM portion 150 again via physical contact between the plurality of pin fins 132 and portion 150.

Under normal operating conditions, the material of PCM portion 150 remains in a solid state within heat exchanger 100. If excess generated heat is transferred, PCM portion 150 is configured to absorb the excess heat by melting at least a portion of the solid material. PCM portion 150 thus acts as a “reservoir” for storing excess heat not transferred to coolant portion 180. Following the transfer to PCM portion 150, the generated heat not absorbed by PCM portion 150 can be transferred to second heat conducting portion 170 via physical contact between portion 150 and a plurality of pin fins 172 included with portion 170 (this may be referred to as a first quantity of generated heat to the PCM portion 150 and a second quantity of generated heat to the second heat conducting portion 170).

The generated heat can then be transferred from the second heat conducting portion 170 to coolant portion 180 which may include circulating air and/or fluid that cools the remaining generated heat (e.g., second quantity of generated heat). Coolant portion 180 absorbs any remaining generated heat in order to maintain PCM portion 150 in a physical state that maximizes heat absorption. Heat is thus apportioned between PCM portion 150 and coolant portion 180 to maximize overall heat absorption in heat exchanger 100. Accordingly, heat exchanger 100 provides both passive and active heat absorption which enables EV charging within a safe temperature range.

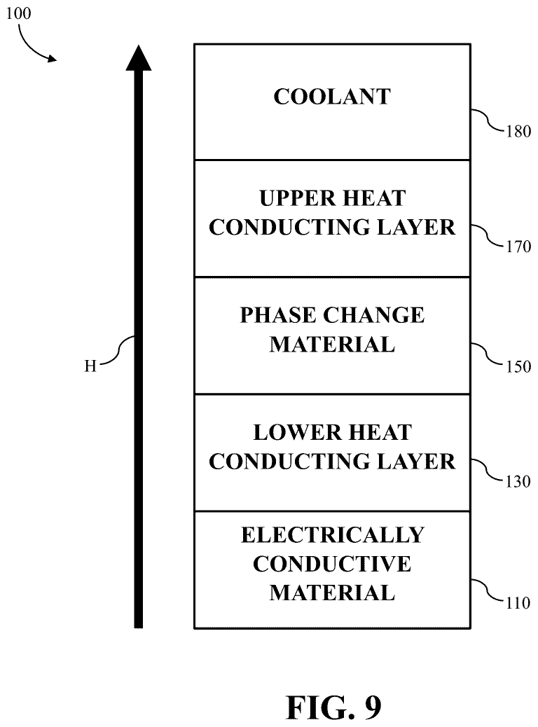

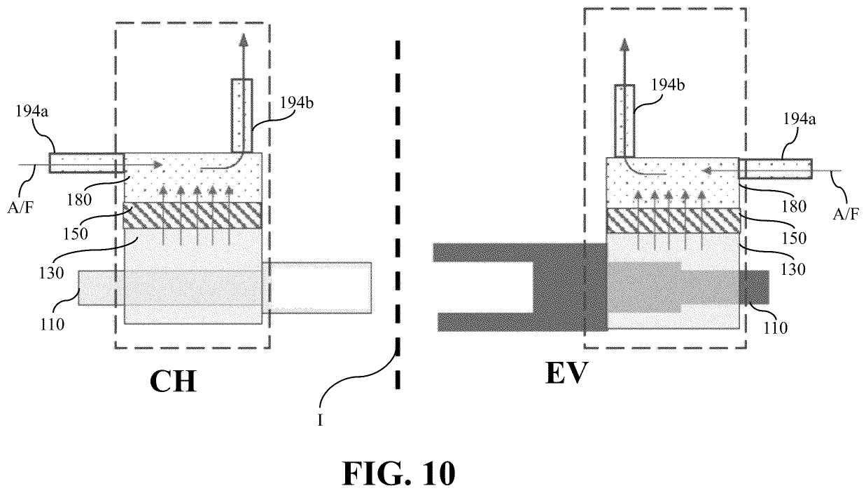

The transfer of heat H from electrically conducting portion 110 to coolant portion 180 is illustrated particularly in FIG. 9. Referring now to FIG. 10, the transfer of heat through heat exchanger 100 may be achieved either on the side of the charging handle CH or on the side of the electric vehicle EV (or both), which are separated by interface I. As described previously, circulating air and/or fluid A/F may enter the enclosure of coolant portion 180 through coolant inlet 194a and subsequently exit out of coolant outlet 194b as illustrated in FIG. 10. Cooling of the charging handle and/or the EV inlet interface can thus be achieved using active cooling via the circulating A/F and/or passive cooling via the phase-change material of PCM portion 150. As such, heat absorption is maximized while maintaining a small form factor for the heat exchanger 100 to fit within EV charging handles. In embodiments, circulating fluid may be water, deionized water, glycol/water solutions, or dielectric fluids such as fluorocarbons and polyalphaolefin.

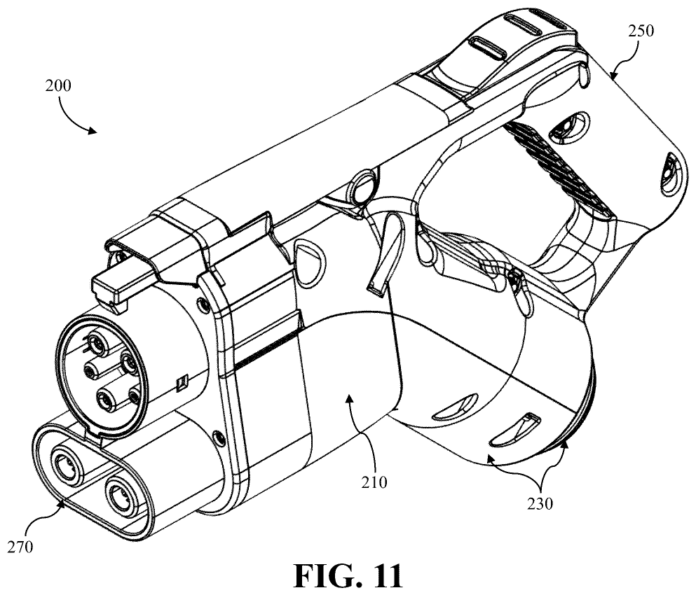

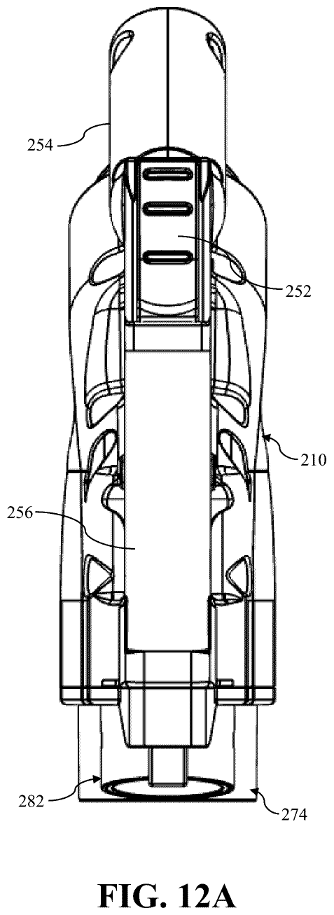

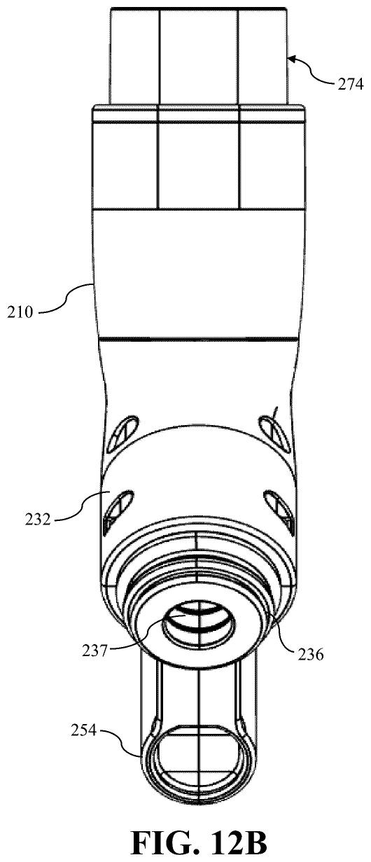

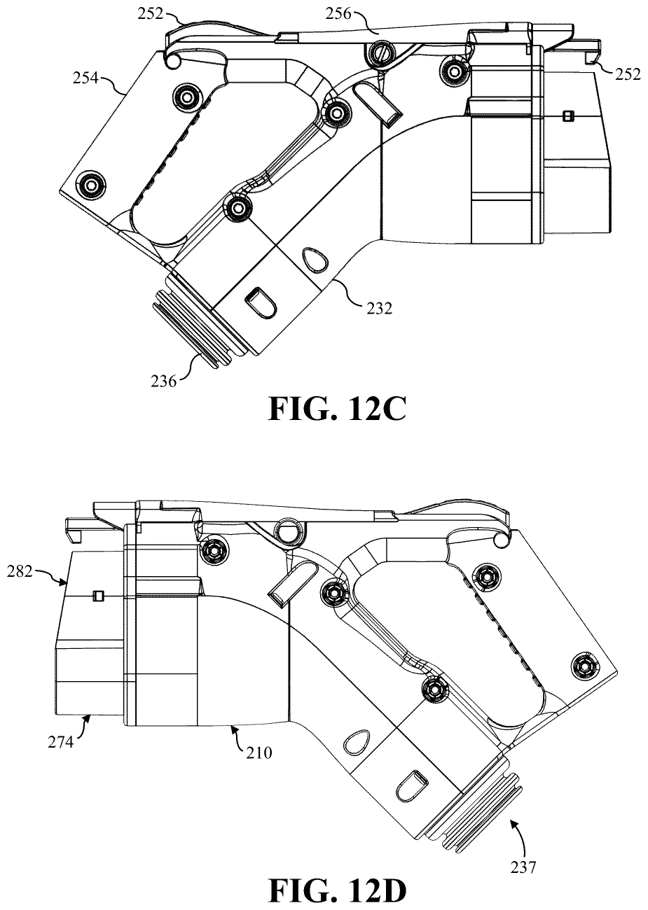

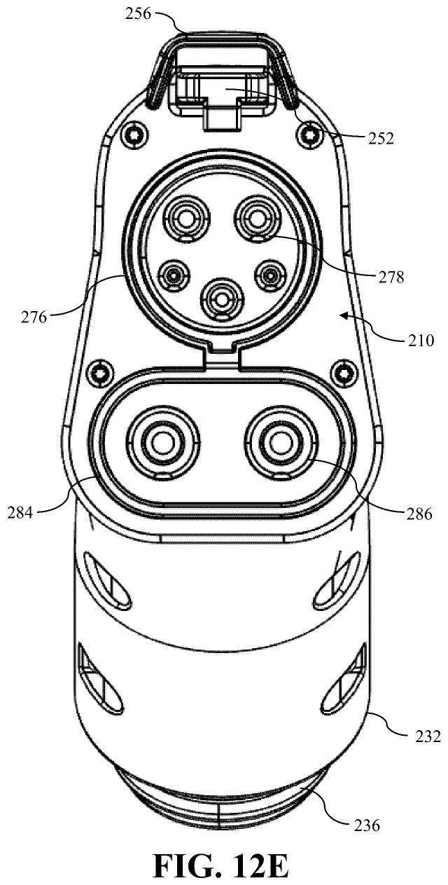

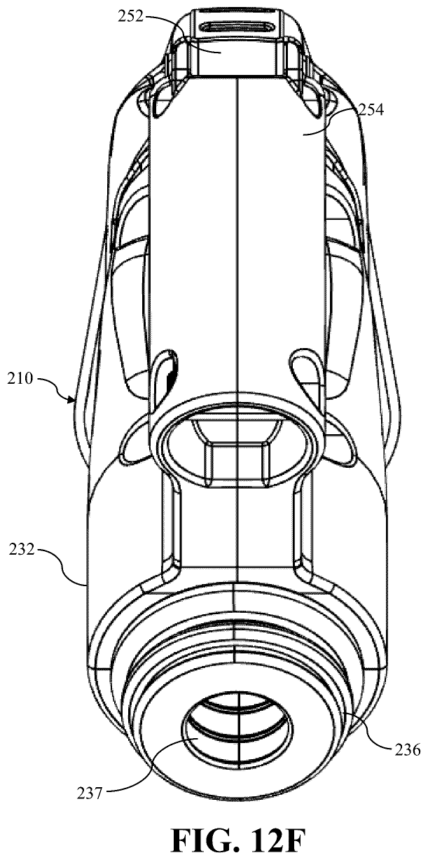

Referring now generally to FIGS. 11-12F, first charging handle 200 for use with an EV may include a housing 210 sized to store various internal mechanical and electrical components 220 for use with first charging handle 200, a cable connector portion 230 configured to receive an electric cable to enable the transfer of electric current into the first charging handle 200, a handle portion 250 for holding and gripping the first charging handle 200 by a user, the handle portion 250 couplable to the cable connector portion 230, and a mating portion 270 configured to mate and connect with an EV inlet interface to transfer electric current from first charging handle 200 into an EV for charging. First charging handle 200 may be manufactured from a variety of materials known to one of ordinary skill in the art, including metals, polymers, composites, ceramics, or combinations thereof. In an embodiment, one or more components of first charging handle 200 are made from a metal and one or more components are made from a polymer.

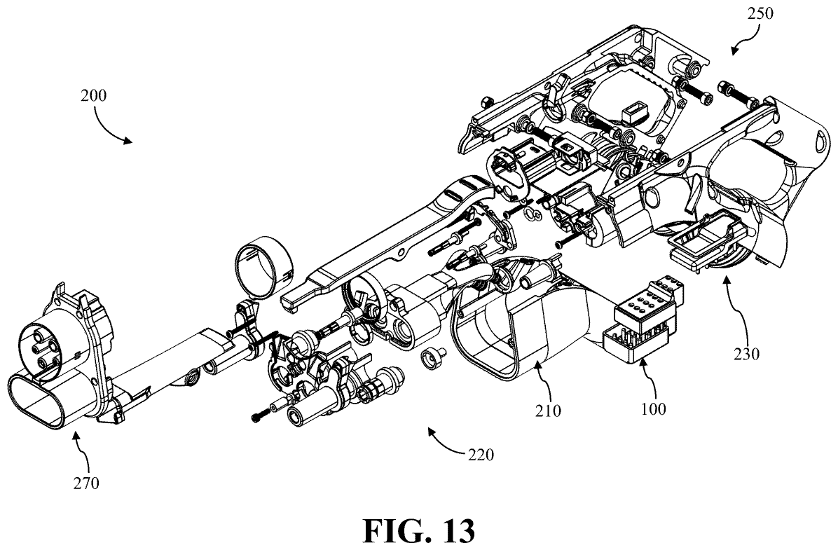

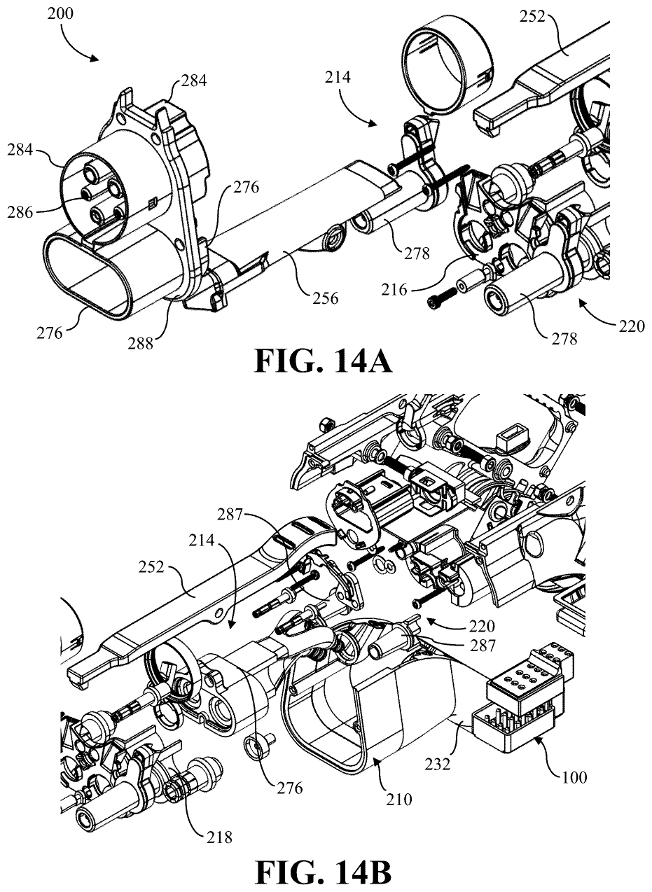

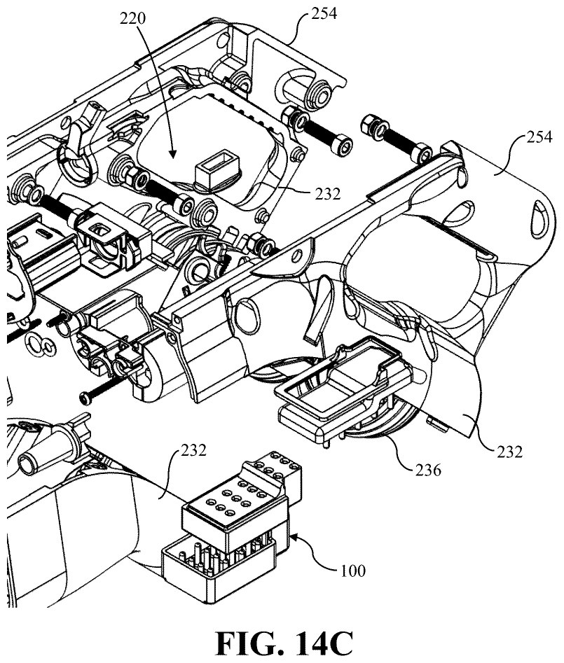

Housing 210 is generally designed to have sufficient internal volume to house various charging-related components known to one of ordinary skill in the art, including, for example: sealing portion 214 with sealing elements for use with one or more conductors stored therein, conductor retaining element 216 for securely holding one or more conductors, and an overmold element 218 generally made from an aluminum overmolding process and being configured to securely hold various metal and polymer components within housing 210 to create a single integral assembly. Housing 210 may also hold various mechanical and electrical components 220 therein, as illustrated particularly in FIGS. 13-14C, which are known to one of ordinary skill in the art of EV charging handles. Examples of such components 220 include fasteners, washers, rings, circuitry, cabling, wire retaining and routing elements, and other such mechanical and electrical components as needed. In an embodiment, housing 210 may include a mechanism for detaching from handle portion 250 as needed (handle portion 250 may include a corresponding detachment mechanism couplable to the detachment mechanism of housing 210).

Heat exchanger 100 may also be disposed within housing 210 and may be configured to operate as described previously. Specifically, heat exchanger 100, when integrated with charging handle 200, can be configured to cool the mated electrical contacts between mating portion 270 and the EV inlet interface using the combined active and passive cooling process. This enables charging handle 200 and/or the EV inlet to operate within a temperature range designated safe by regulatory bodies. For example, the maximum external temperature of charging handle 200 as dictated by IEC 62196-1, Section 16.5, may be 50° C. (122° F.) for metal parts and 60° C. (140° F.) for non-metal parts. These temperatures correspond to the portions of the charging handle 200 and EV inlet interface grasped by a user, such as housing 210 and handle portion 250. Moreover, other components of charging handle 200, such as the connector pins within mating portion 270, may be configured to have a maximum temperature of 105° C. (221° F.) during operation.

Cable connector portion 230 may include a cable connector housing 232 couplable to housing 210 and handle portion 250, and a cable receiving element 236 with a threaded or non-threaded passageway 237 received within cable connector housing 232. Cable connector housing 232 is generally designed to have sufficient structure to accommodate the structures of housing 210 and handle portion 250 (i.e., cable connector housing 232 generally has a form factor corresponding to the form factors of housing 210 and handle portion 250). As the name suggests, cable receiving element 236 may be configured to receive a portion of an electric cable within passageway 237. Passageway 237 may be designed to securely receive an electric cable therein, for example using threads that correspond to opposing threads included with the electric cable. Moreover, passageway 237 can be configured to enable the transfer of electric current through charging cable 200 starting with cable connector portion 230.

Generally, the electric cable is attachable and detachable from cable receiving element 236 by a user who physically forces contact between the electric cable and element 236. In embodiments, the electric cable can be removably couplable to the cable receiving element 236 and passageway 237, or can be fixedly couplable to these components such that the electric cable is unitary with the charging handle 200. In an embodiment, the diameter and length of passageway 237 can range from approximately one to three inches, though measurements less than or greater than this range are contemplated by this disclosure. In an embodiment, cable connector portion 230 may be removably couplable to housing 210 and handle portion 250, or integrally connectable together to form a single unitary assembly.

Handle portion 250 may include a release latch 252 configured to release the charging handle 200 from the EV inlet interface when charging is complete, a grip 254 that a user may grasp and hold, and a release latch cover 256 positioned over a substantial segment of the release latch 252 (e.g., the trigger and the release element of the release latch 252 may be uncovered, as illustrated in the figures). Release latch 252 and release latch cover 256 may both have a thin, substantially rectangular geometry as illustrated in the figures. In an embodiment, release latch 252 may include one or more textured elements on the trigger for more comfortable use. The trigger of release latch 252 is generally elevated above the remaining segments of release latch 252 so that a user can more easily press down on the trigger to release charging handle 200 from an EV inlet. In an embodiment, grip 254 may include one or more textured elements for more comfortable use.

In an embodiment, handle portion 250 may be removably couplable to cable connector portion 230 or may be integrally connectable to form a single handle/cable connector portion. When removably couplable, handle portion 250 may be detached from first charging handle 200 and reattached to a different charging handle having the same or different geometry than charging handle 200 (or a charging handle configured for use with an alternating current (AC) configuration in addition to a direct current (DC) configuration). Since there are multiple charging handle configurations depending on power source (e.g., AC, DC, or AC and DC) and region in the world (e.g., North America, Europe, or China), a removably couplable handle portion 250 can advantageously be used with different charging handles with limited to no loss of design or functionality characteristics. Accordingly, in such an embodiment, handle portion 250 can act as a “universal” handle rather than being restricted only to first charging handle 200.

Mating portion 270 is generally couplable to housing 210 and handle portion 250, and may include a first plug-in connection 274 having a first connection housing 276 and a plurality of connectors 278, a second plug-in connection 282 having a second connection housing 284 and a plurality of connectors 286, one or more connector pins 287 couplable to each plurality of connectors 278, 286, and a mating frame 288 couplable to both first and second plug-in connections 274, 282. Generally, first and second plug-in connections 274, 282 are configured to be couplable to an EV inlet to enable direct transfer of electric current from the plurality of connectors 278, 286 to the EV. In an embodiment, mating portion 270 may be removably couplable to housing 210 via one or more fasteners or another securing mechanism, or mating portion 270 may be integrally connectable to housing 210 to form a single unitary portion. In an embodiment, mating frame 288, which can have a thin, substantially rectangular or circular geometry, may abut separate external surfaces of housing 210 and handle portion 250, and can also be in contact with release latch cover 256. As illustrated specifically in FIG. 12E, mating frame 288 may include a rectangular opening by which the release element of release latch 252 extends through (i.e., the release element can lock charging handle 200 to the EV inlet).

Plurality of connectors 278, 286 may include various mechanical and electrical components as needed to enable the transfer of electric current (selection of such components is within the skill set of one of ordinary skill in the art). As illustrated, mating portion 170 can be configured for use with a direct current (DC) power source based on the configuration of first and second plug-in connections 274, 282 (e.g., CCS1 or CCS2 power source). In embodiments, the configuration of first and second plug-in connections 274, 282 may be altered to accommodate an alternating current (AC) power source (e.g., J1772 power source), or a power source that uses both AC and DC power (e.g., Tesla (NACS) power source).

As illustrated, first connection housing 276 may have a cylindrical geometry while second connection housing 284 may have a slotted geometry. Other geometries for first and second connection housings 276, 284 are contemplated by this disclosure, including rectangular, triangular, or irregular geometries. In general, first and second connection housings 276, 284 are designed with enough space to comfortably contain plurality of connectors 278, 286 with a gap between each outermost connector 278, 286 and the respective inner walls of housings 276, 284.

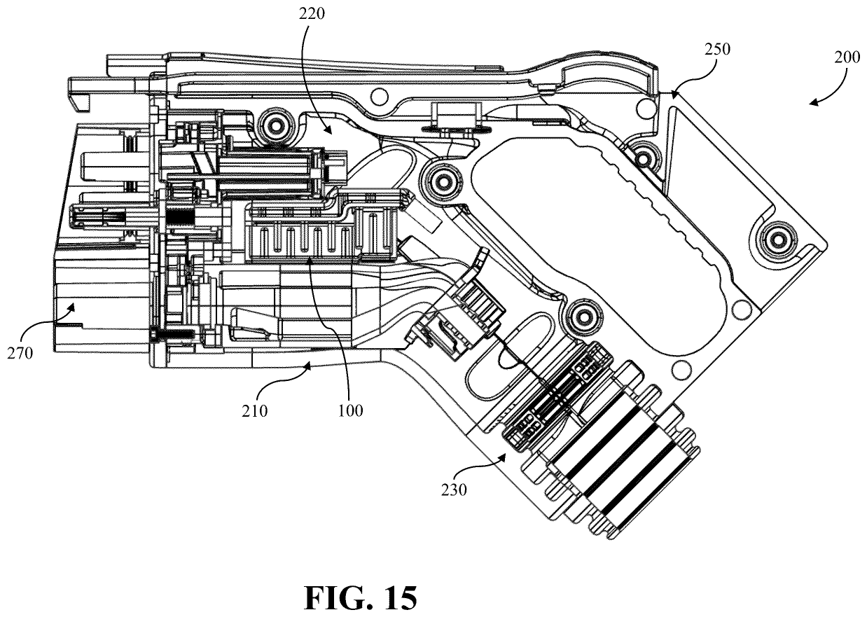

Referring now generally to FIGS. 13-15, exploded and cross-section views of charging handle 200 illustrate how housing 210, cable connector portion 230, handle portion 250, and mating portion 270, along with various mechanical and electrical components 220 included within housing 210, can be assembled as contemplated by this disclosure. In particular, heat exchanger 100 is depicted in these figures as having a form factor to ensure comfortable placement within charging handle 200 to enable active and passive cooling when charging handle 200 is used. It should be understood that heat exchanger 100 may be designed with multiple different geometrical configurations with varying form factors still suitable for positioning and use within charging handle 200.

In an embodiment, charging handle 200 may include a plurality of pins (depicted but not labeled) each couplable to an individual mount that can be crimped to an electric cable. In case of damage to charging handle 200, the plurality of pins can be unscrewed and replaced as needed. This eliminates the need to cut the electric cable from a first, original pin and crimp the cable to a second, new pin for continued use of charging handle 200.

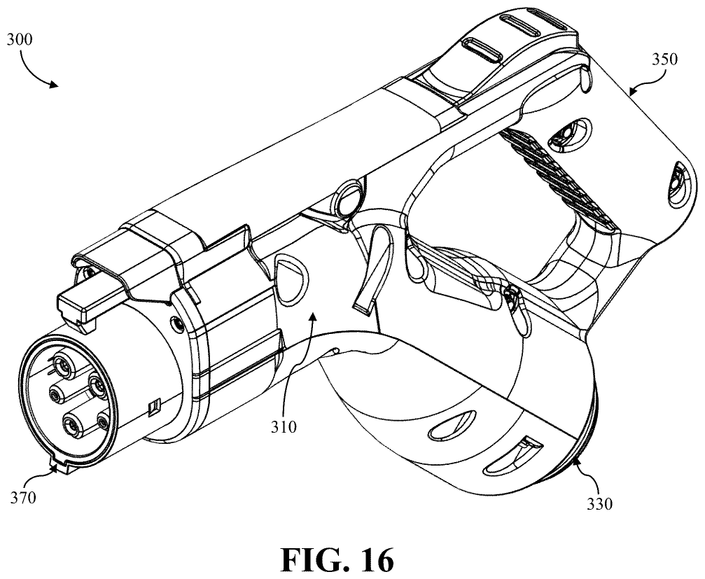

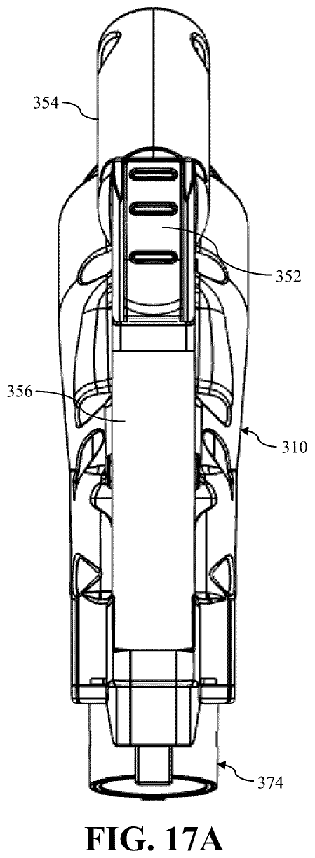

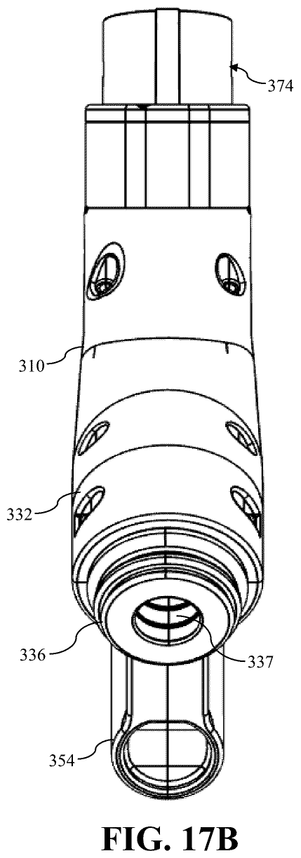

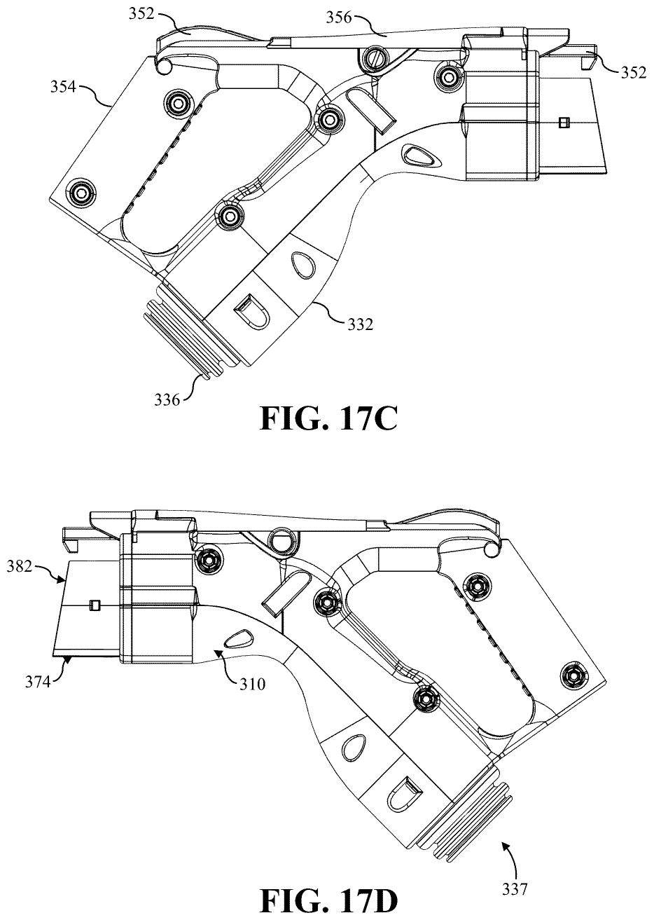

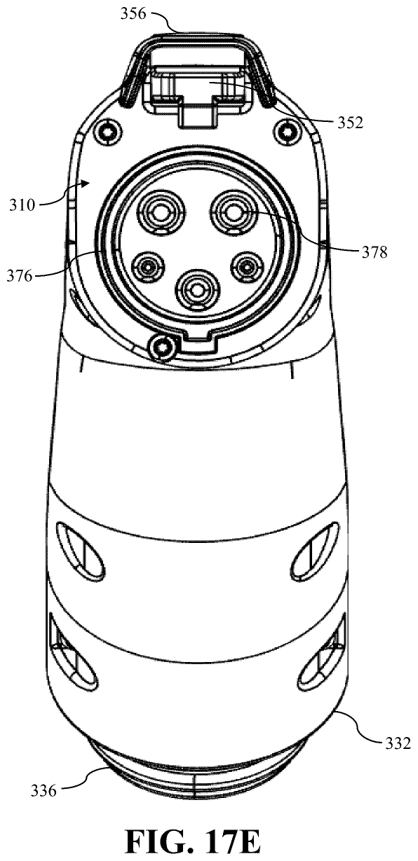

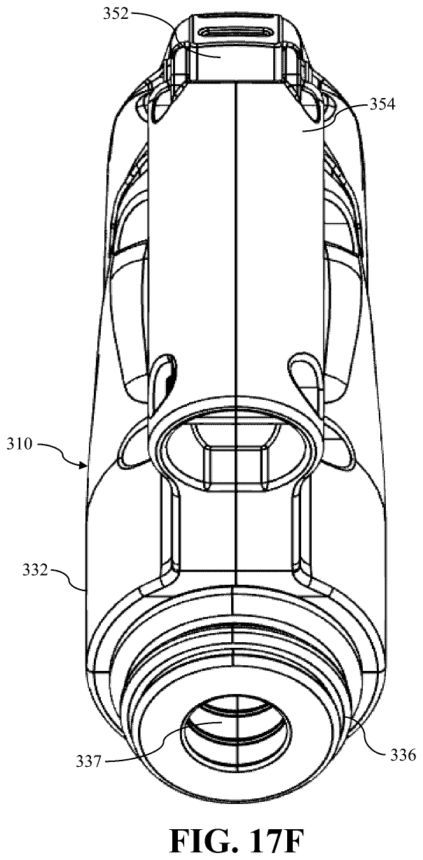

Referring now generally to FIGS. 16-17F, second charging handle 300 for use with an EV may include a housing 310 sized to store various internal mechanical and electrical components 320 for use with second charging handle 300, a cable connector portion 330 configured to receive an electric cable to enable the transfer of electric current into the second charging handle 300, a handle portion 350 for holding and gripping the second charging handle 300 by a user, the handle portion 350 couplable to the cable connector portion 330, and a mating portion 370 configured to mate and connect with an EV inlet interface to transfer electric current from second charging handle 300 into an EV for vehicle charging.

Second charging handle 300 has many similarities to first charging handle 200, and for simplicity the description of common components is not repeated in the following. Like reference numerals and features names may designate like feature names throughout that are corresponding or analogous. Moreover, it should be understood that in embodiments, heat exchanger 100 can be included with second charging handle 300 and configured to operate similarly as with first charging handle 200 to enable active and passive cooling of the electrically conducting pathways during the charging process. Alternatively, second charging handle 300 may be configured to operate without heat exchanger 100 using a different cooling mechanism.

Notably, in an embodiment, second charging handle 300 only includes a single plug-in connection 274 having a connection housing 276 and a plurality of connectors 278, rather than first and second plug-in connections 274, 282 as with first charging handle 200. In such an embodiment, second charging handle 300 only requires a single plug-in connection 274 because second charging handle 300 is configured to operate with an AC power source (e.g., J1772) rather than a DC power source (e.g., CCS1 or CCS2) as with first charging handle 200. The difference in plug-in connections between charging handles 200 and 300, as well as other charging handle designs contemplated by this disclosure, is further illustrated and described in U.S. Provisional Application No. 63/483,273, which this disclosure claims the benefit of and is incorporated by reference herein in its entirety.

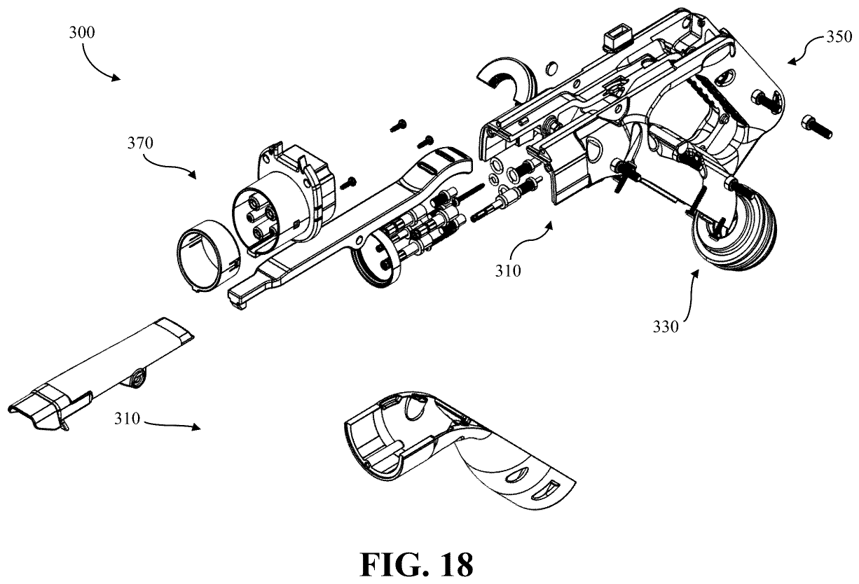

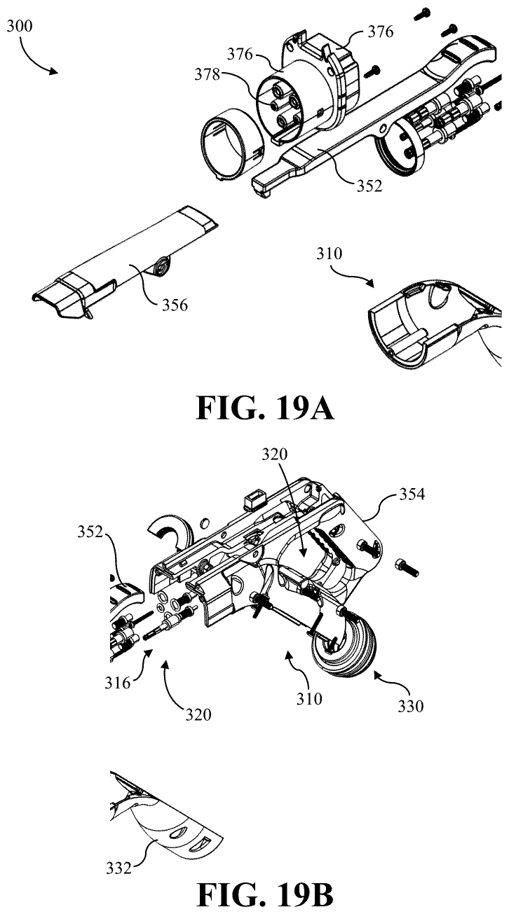

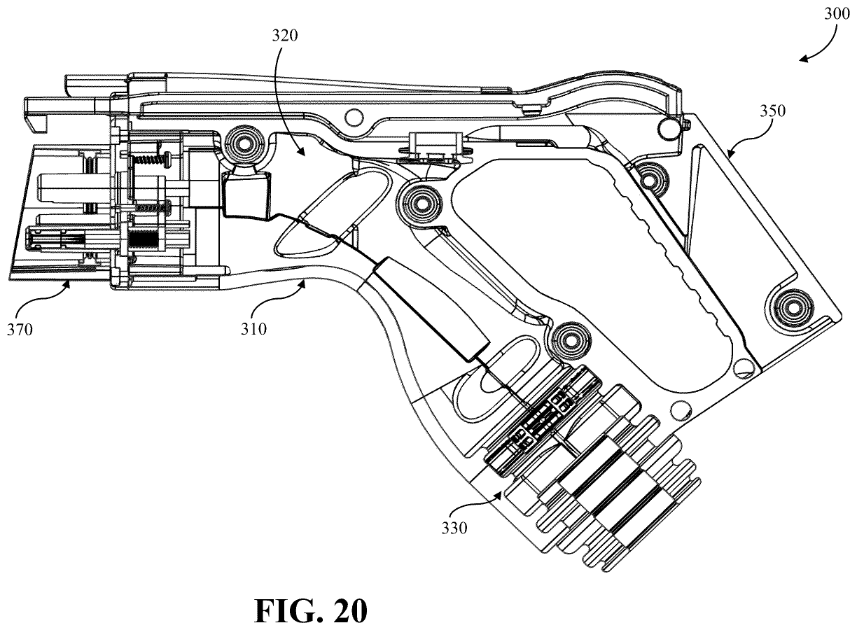

Referring now generally to FIGS. 18-20, exploded and cross-section views illustrate the assembly of second charging handle 300 in a similar manner as first charging handle 200. It should be understood that second charging handle 300 may include various mechanical and electrical components 320 not required for the DC configuration of first charging handle 200, but required to enable the AC configuration of the presently described charging handle 300. One of ordinary skill in the art has sufficient skill and knowledge to select and implement suitable mechanical and electrical parts 320 into second charging handle 300.

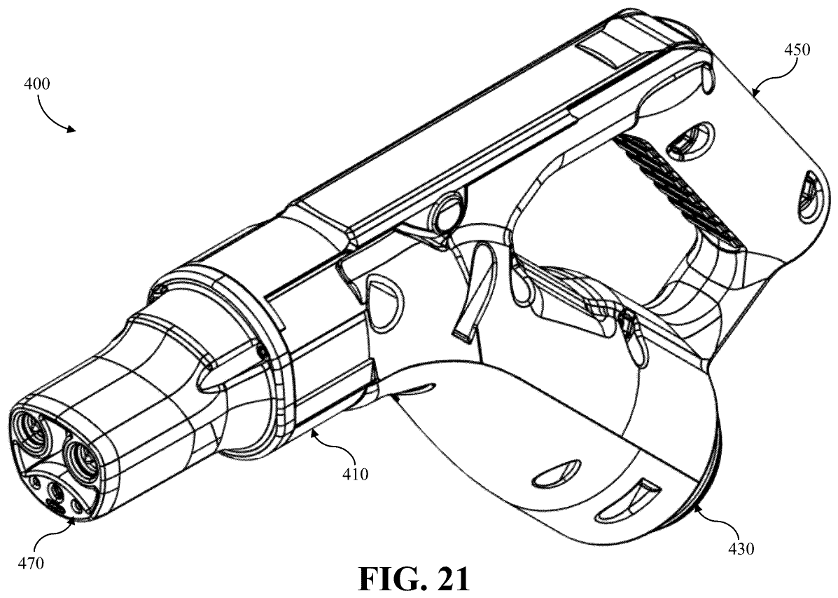

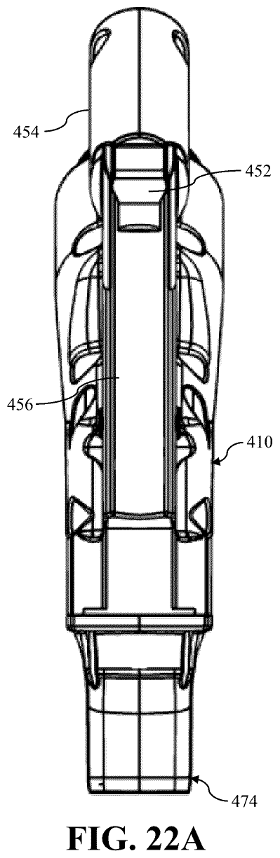

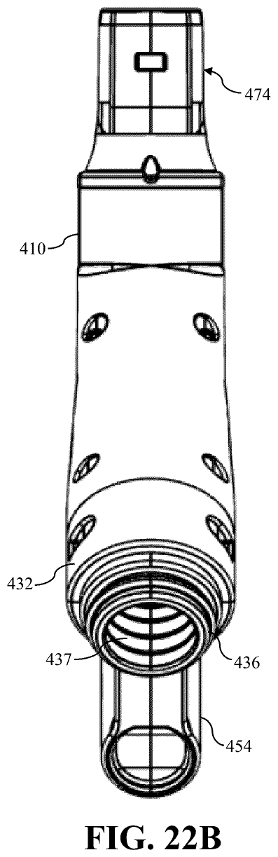

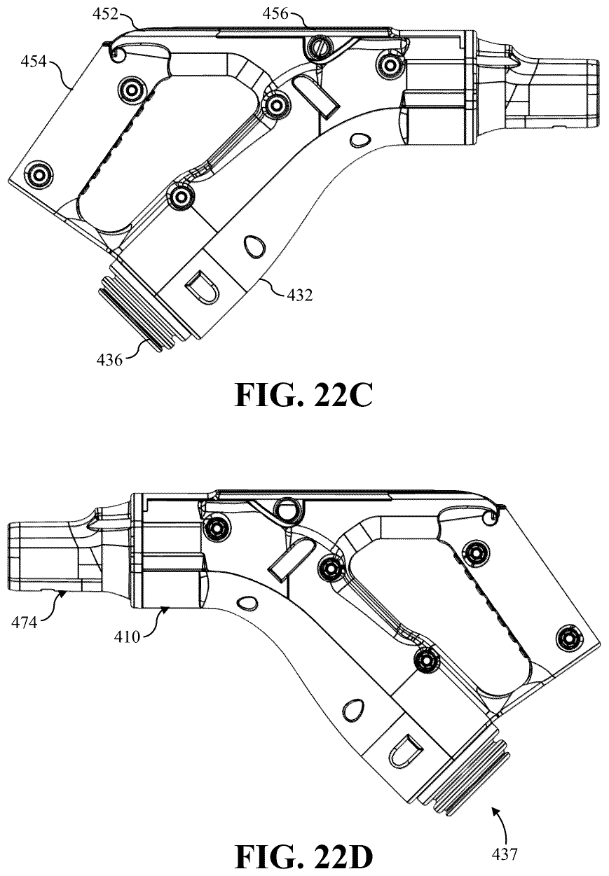

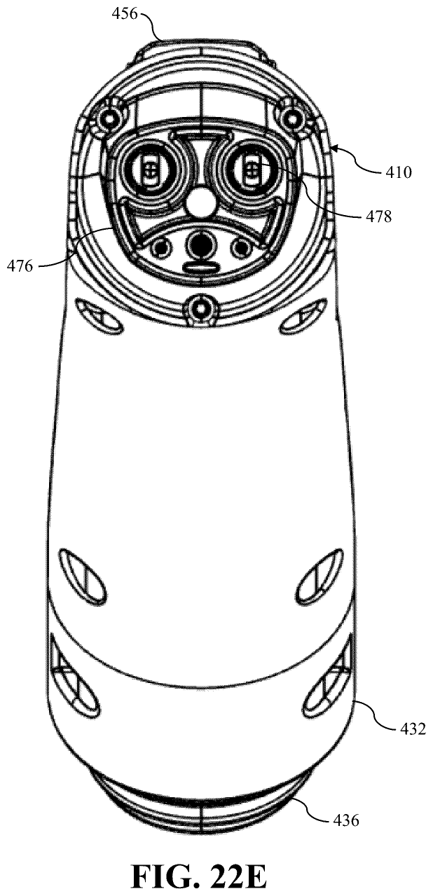

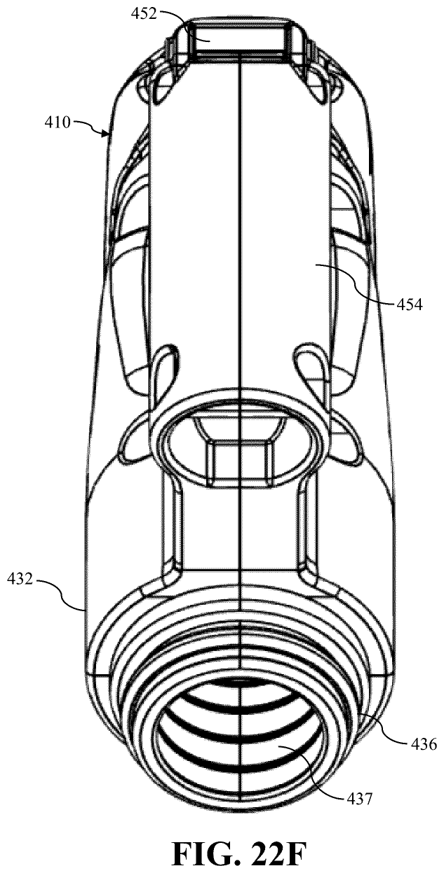

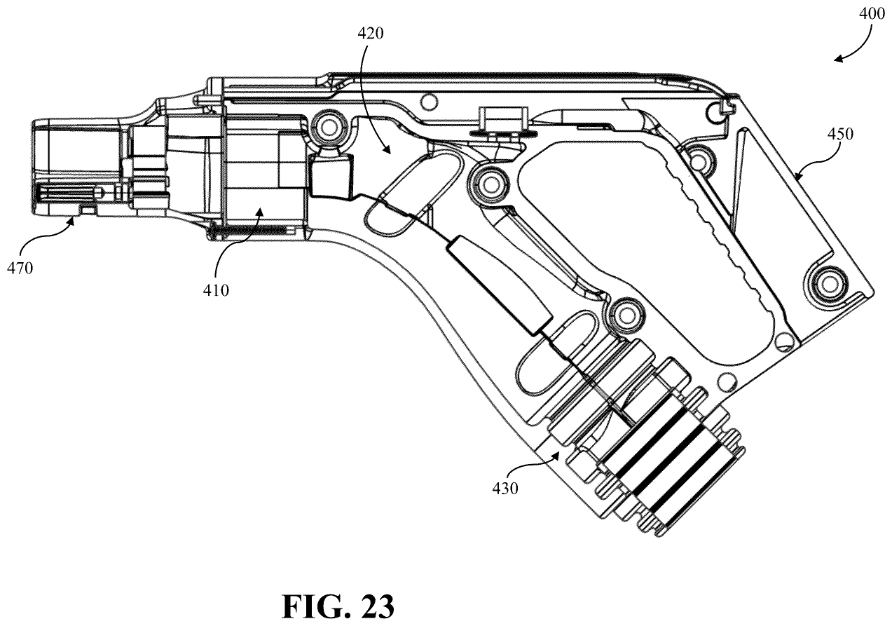

Referring now generally to FIGS. 21-23, third charging handle 400 for use with an EV may include a housing 410 sized to store various internal mechanical and electrical components 420 for use with third charging handle 400, a cable connector portion 430 configured to receive an electric cable to enable the transfer of electric current into the third charging handle 400, a handle portion 450 for holding and gripping the third charging handle 400 by a user, the handle portion 450 couplable to the cable connector portion 430, and a mating portion 470 configured to mate and connect with an EV inlet interface to transfer electric current from third charging handle 400 into an EV for vehicle charging.

Third charging handle 400 has many similarities to first and second charging handles 200, 300, and for simplicity the description of common components is not repeated in the following. Like reference numerals and features names may designate like feature names throughout that are corresponding or analogous. Moreover, it should be understood that in embodiments, heat exchanger 100 can be included with third charging handle 300 and configured to operate similarly as with first charging handle 200 to enable active and passive cooling of the electrically conducting pathways during the charging process. Alternatively, third charging handle 300 may be configured to operate without heat exchanger 100 using a different cooling mechanism.

Third charging handle 400 may follow the North American Charging Standard (“Tesla (NACS)”) based on the configuration of mating portion 470. As such, third charging handle 400 can be configured to operate with a dual alternating current (AC) and direct current (DC) power source to charge an EV. Like mating portion 370, mating portion 470 may include only a single plug-in connection 474 having a connection housing 476 and a plurality of connectors 478 rather than multiple plug-in connections. The geometry of housing 410, cable connector portion 430, and handle portion 450 may be sized differently to compensate for the single plug-in connection 474 (e.g., overall, third charging handle 400 may have a smaller form factor than first charging handle 200, for example).

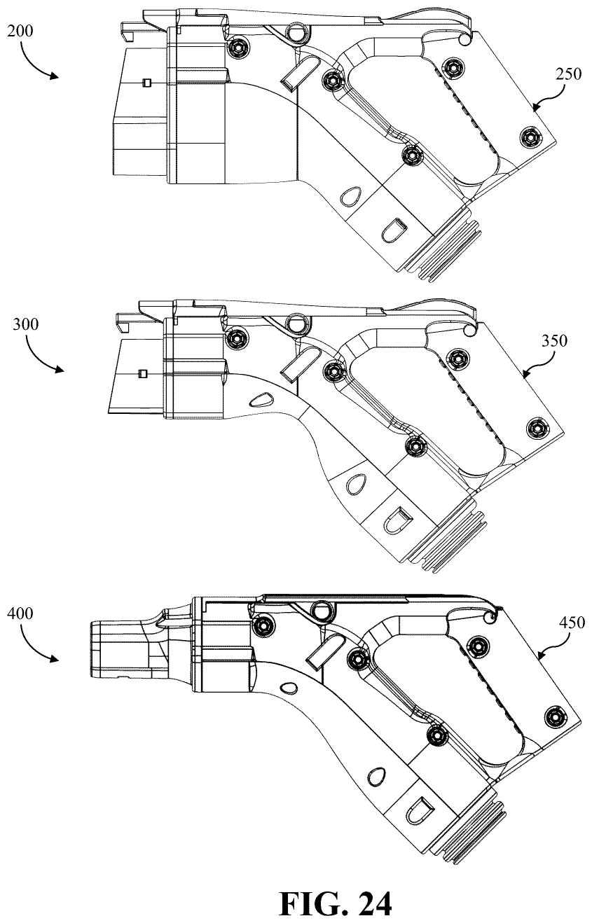

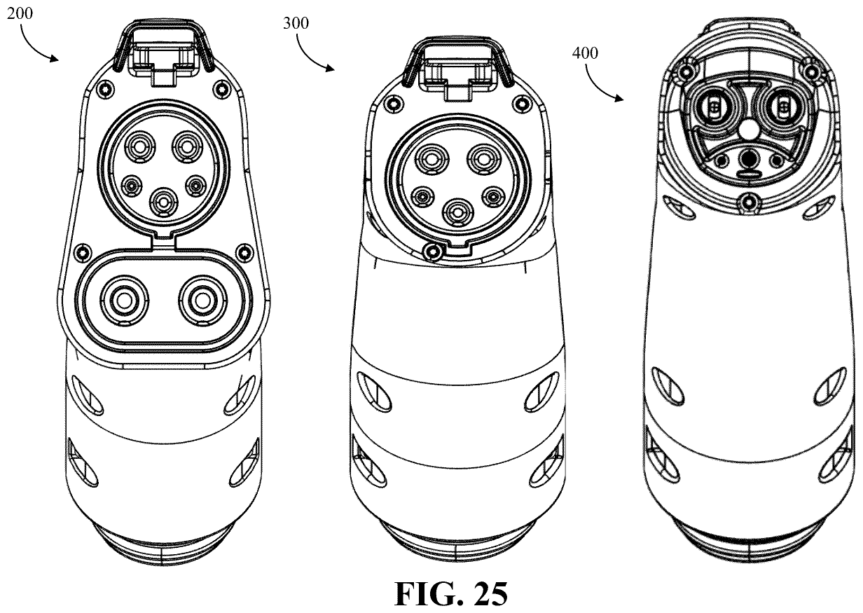

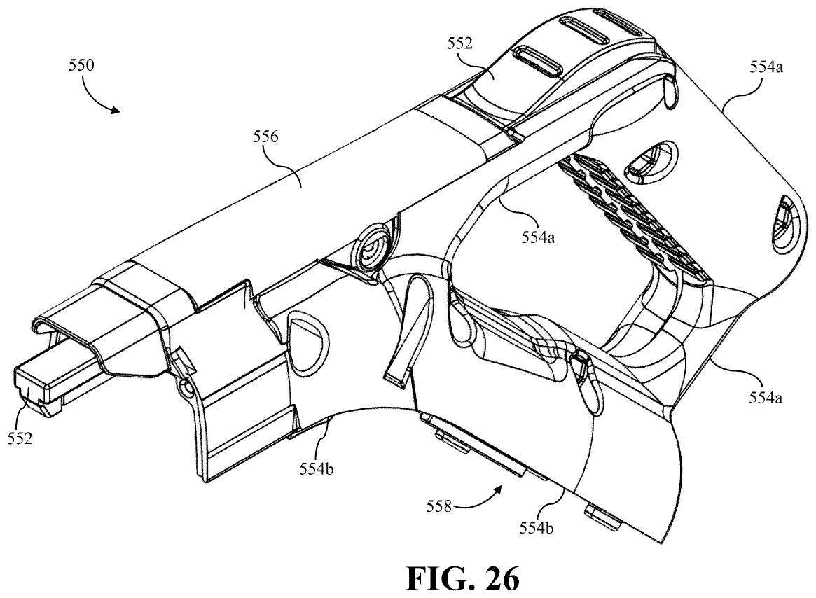

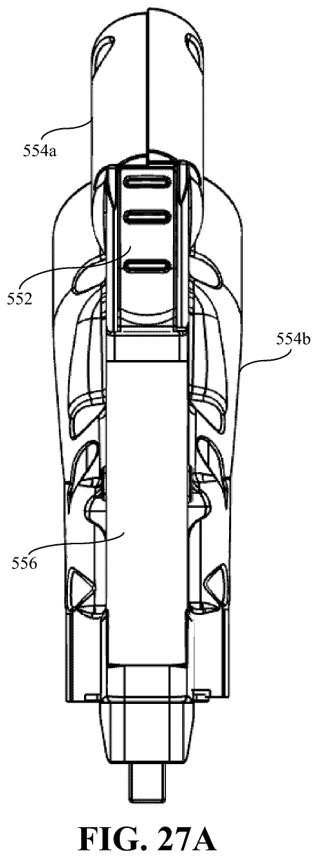

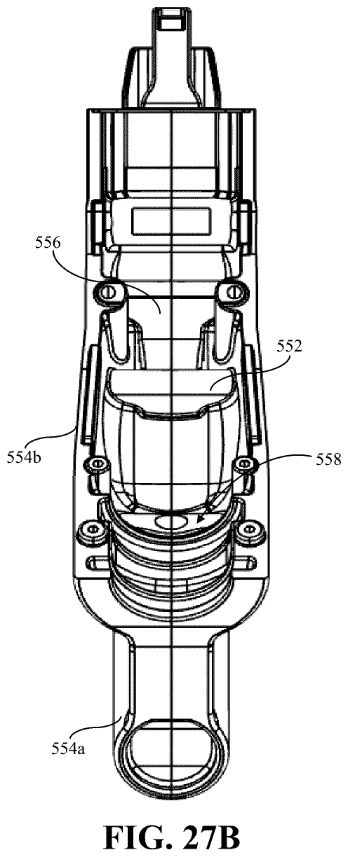

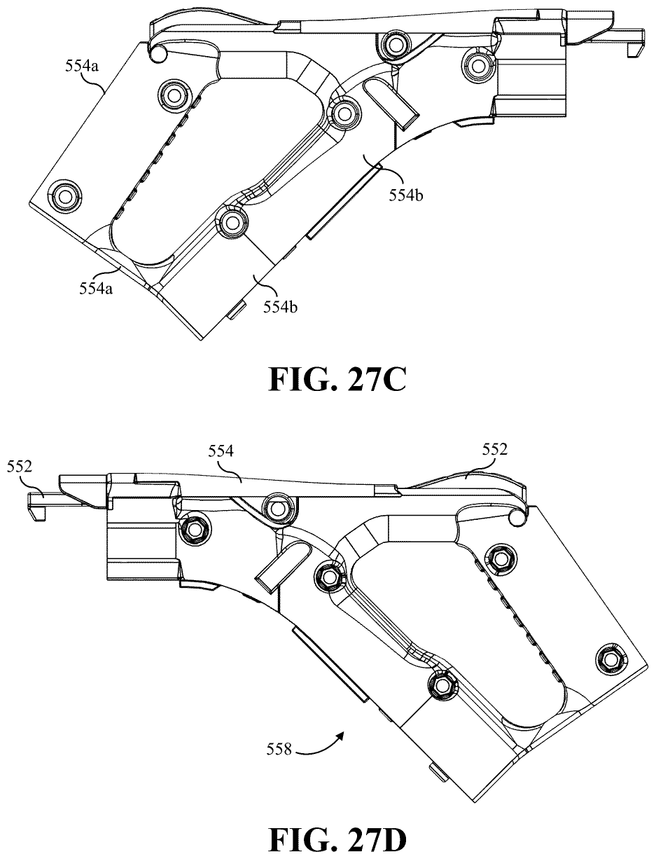

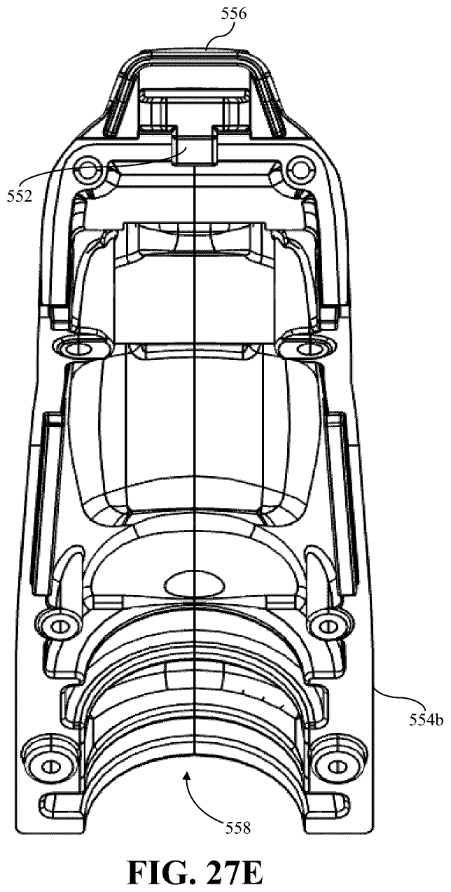

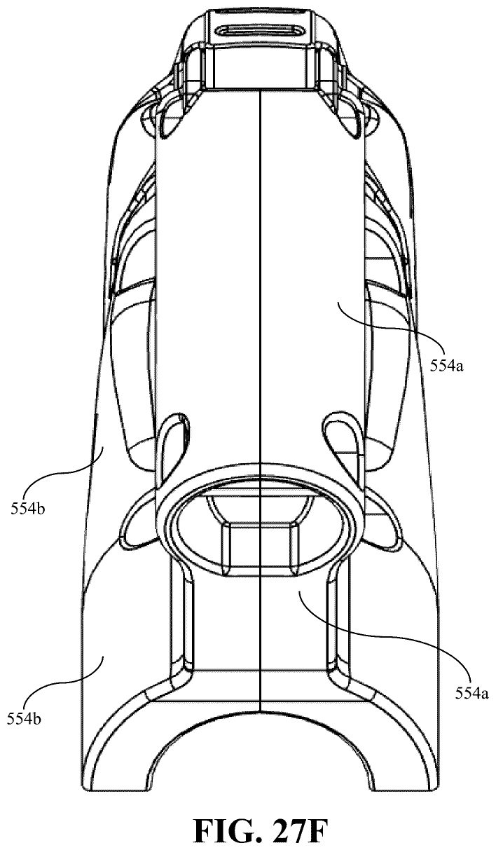

Referring now generally to FIGS. 26-27F, handle portion 550 for use with a charging handle, such as charging handles 200, 300, and 400 shown in FIGS. 24 and 25, may include a release latch 552 configured to release a charging handle from an EV inlet interface when charging is complete, an upper grip segment 554a that a user may grasp and hold, along with a lower grip segment 554b configured to be couplable to a cable connector portion and a housing of a charging cable via an attachment mechanism 558, and a release latch cover 556 positioned over a substantial segment of the release latch 552. Attachment mechanism 558 may use fasteners, passive or active anchors, adhesives, velcro, or any other suitable fastening mechanism to couple handle portion 550 to other portions of a charging handle. Generally, attachment mechanism 558 may be couplable with first, second, or third charging handles 200, 300, 400, or other charging handles described in U.S. Provisional Application No. 63/483,273.

Handle portion 550 has many similarities to handle portions 250, 350, and 450, and for simplicity the description of common components is not repeated in the following. Like reference numerals and features names may designate like feature names throughout that are corresponding or analogous. Notably, handle portion 550 may be characterized as being “universal” in that it can be used with multiple different charging handle designs and geometries, including charging handles that operate with AC power, DC power, or both AC and DC power. The sleek design and versatile functionality of handle portion 550 advantageously enables use of different types of charging handle configurations while retaining the same look, feel, and operation of handle portion 550. In embodiments, the easy snap-in connection between attachment mechanism 558 and other charging handle portions (e.g., charging handle housings, cable connector and mating portions) provides for swift swapping of one charging handle configuration for another.

The charging handle and handle portion embodiments described herein may be configured for use with AC and/or DC power sources. Example AC power charging handle configurations include J1772 (Type 1), Mennekes (Type 2), and GB/T. Example DC power charging handle configurations include CCS1, CCS2, CHAdeMO, and GB/T. An example charging handle configuration suitable for use with AC and DC power sources is Tesla (NACS). Such AC and/or DC charging configurations are illustrated in the figures of the present disclosure as well as the figures of U.S. Provisional Application No. 63/483,273.

Various embodiments of systems, devices, and methods have been described herein. These embodiments are given by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill will recognize that the subject matter hereof may comprise fewer features than illustrated in any individual embodiment. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill. Moreover, elements of one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A combined active and passive heat exchanger for use during electric vehicle charging, comprising:
an electrically conducting portion configured to receive electric current from an external source, the electric current creating heat generation in the electrically conducting portion;
a first heat conducting portion coupled to the electrically conducting portion, the first heat conducting portion configured to receive the heat generation from the electrically conducting portion;
a phase change material (PCM) portion including a PCM configured to change physical state in response to heat absorption, the PCM portion coupled to the first heat conducting portion such that the heat generation is absorbed by the PCM portion, wherein the PCM portion is configured to retain a first quantity of the heat generation;
a second heat conducting portion coupled to the PCM portion, the second heat conducting portion configured to receive a second quantity of the heat generation from the PCM portion; and
a coolant portion coupled to the second heat conducting portion, the coolant portion configured to receive the second quantity of heat generation from the second heat conducting portion, the coolant portion configured to cool the second quantity of heat generation using a fluid circulating through the coolant portion,
wherein absorption of the first quantity of heat generation by the PCM portion and cooling of the second quantity of heat generation by the coolant portion decreases the temperature of the external source.

2. The combined active and passive heat exchanger of claim 1, wherein the first heat conducting portion is configured to receive the heat generation from the electrically conducting portion via a first set of one or more pin fins.

3. The combined active and passive heat exchanger of claim 2, wherein the first set of one or more pin fins are in contact with the electrically conducting portion.

4. The combined active and passive heat exchanger of claim 1, wherein the PCM portion is configured to change from a solid to a liquid, and from a liquid to a solid.

5. The combined active and passive heat exchanger of claim 1, wherein the second heat conducting portion is configured to receive the second quantity of the heat generation from the PCM portion via a second set of one or more pin fins.

6. The combined active and passive heat exchanger of claim 1, wherein the coolant portion includes an inlet for receiving the fluid and an outlet for removing the fluid, the inlet and the outlet being connected by one or more internal channels in the coolant portion to enable circulation of the fluid therein.

7. The combined active and passive heat exchanger of claim 1, wherein the external source is an electrical contact located within an electric vehicle charging handle.

8. The combined active and passive heat exchanger of claim 1, wherein the external source is a charging inlet of an electric vehicle.

9. The combined active and passive heat exchanger of claim 1, wherein the first and second quantities of heat generation are apportioned between the PCM portion and the coolant portion to maximize heat absorption by the PCM portion.

10. The combined active and passive heat exchanger of claim 1, further comprising a thermal spacer positioned between the PCM portion and the coolant portion.

11. A combined active and passive heat exchanger for use during electric vehicle charging, comprising:
an electrically conducting portion configured to receive electric current from an external source, the electric current creating heat generation in the electrically conducting portion;
a first heat conducting portion in contact with the electrically conducting portion, the first heat conducting portion configured to receive the heat generation from the electrically conducting portion via a first set of one or more pin fins;
a phase change material (PCM) portion including a PCM configured to change physical states in response to heat absorption, the PCM portion being in contact with the first heat conducting portion such that the heat generation is absorbed by the PCM portion, wherein the PCM portion is configured to retain a first quantity of the heat generation;
a second heat conducting portion in contact with the PCM portion, the second heat conducting portion configured to receive a second quantity of the heat generation from the PCM portion via a second set of one or more pin fins; and
a coolant portion in contact with the second heat conducting portion, the coolant portion configured to receive the second quantity of heat generation from the second heat conducting portion, the coolant portion having an inlet for receiving fluid and an outlet for removing the fluid, the inlet and the outlet being connected by one or more internal channels in the coolant portion, wherein the coolant portion is configured to cool the second quantity of heat generation using a fluid circulating through the one or more internal channels,
wherein absorption of the first quantity of heat generation by the PCM portion and cooling of the second quantity of heat generation by the coolant portion decreases the temperature of the external source.

12. The combined active and passive heat exchanger of claim 11, wherein the first and second sets of one or more pin fins are interlaced within a plurality of apertures defined by the PCM portion.

13. The combined active and passive heat exchanger of the claim 11, wherein the electrically conducting portion is in direct contact with the external source such that the heat generation from the electric current is received entirely by the electrically conducting portion.

14. The combined active and passive heat exchanger of claim 11, wherein the PCM portion is configured to change from a solid to a liquid, and from a liquid to a solid.

15. The combined active and passive heat exchanger of claim 11, wherein the external source is an electrical contact located within an electric vehicle charging handle.

16. The combined active and passive heat exchanger of claim 11, wherein the external source is a charging inlet of an electric vehicle.

17. The combined active and passive heat exchanger of claim 11, wherein the first and second quantities of heat generation are apportioned between the PCM portion and the coolant portion to maximize heat absorption by the PCM portion.

18. The combined active and passive heat exchanger of claim 11, further comprising a thermal spacer positioned between the PCM portion and the coolant portion, the thermal spacer including an opening through which the second set of one or more pin fins are received.

19. An electric vehicle charging handle, comprising:
a housing;
a cable connector portion coupled to the housing, the cable connector portion configured to receive an electric cable for transferring electric current into the charging handle;
a handle portion coupled to the housing and to the cable connector portion, the handle portion configured for gripping by a user of the charging handle;
a mating portion configured for connection to an electric vehicle inlet; and
a combined active and passive heat exchanger disposed within the housing, the heat exchanger in electrical contact with the cable connector portion such that electric current from the electric cable can be received by the heat exchanger, the heat exchanger configured to passively cool heat generation by the electric current using a phase change material and to actively cool the heat generation using a circulating fluid, whereby passive and active cooling decreases the temperature within the electric vehicle charging handle.

20. The electric vehicle charging handle of claim 19, wherein the handle portion includes an attachment mechanism configured to couple and decouple the handle portion from both the housing and the cable connector portion.
